(19) United States
(12) Patent Application Publication
(10) Pub. No.: US 2009/0016354 A1
(43) Pub. Date: Jan. 15, 2009

(54) INFORMATION PROCESSING APPARATUS AND INFORMATION PROCESSING SYSTEM

(76) Inventor: Takashi ISOBE, Machida (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/958,787

(22) Filed: Dec. 18, 2007

(30) Foreign Application Priority Data
Jul. 11, 2007 (JP) 2007-182205

(51) Int. Cl. H04L 12/56

(52) U.S. Cl. 370/395.4

(57) ABSTRACT

A compact, energy-saving and dynamic reconfigurable information processing apparatus achieving high-performance server services for application layers such as databases. Multiple PE matrices are formed in the dynamic reconfigurable processor of an apparatus containing that DRP. A scheduling unit is mounted in the packet I/O for deciding which PE matrix will process subsequent packets while one PE matrix is processing the first packet. When the second packet must be processed based on the same configuration information as the first packet, and the third packet must be processed based on configuration information different from the first packet, the scheduling unit makes the second packet wait until processing of the first packet is complete, and then gives priority to the third packet for processing in the second PE matrix.

### CLAIM OF PRIORITY

The present application claims priority from Japanese application JP 2007-182205 filed on Jul. 11, 2007, the content of which is hereby incorporated by reference into this application.

### FIELD OF THE INVENTION

The present invention relates to technology for providing a server service such as for databases by receiving packets transferred over a network, implementing different processes according to the communication state between the host and the terminal sending or receiving the packets over a network, and changing the data accumulated within the apparatus, or generating new packets and transmitting them outside the apparatus.

### BACKGROUND OF THE INVENTION

Parallel advances in ubiquitous computing and the fusion of broadcast and communications have prompted demands from both backend and access users to improve processor performance and provide more diversified services. Meeting these needs requires implementing server services (database: DB) query transactions, anomaly prevention (Internet security), etc.) using ubiquitous devices (Radio Frequency Identification (RFID)/sensors/cameras) on appliances dispersed on edge networks, and improving the response speed and processing performance of the server service.

The term “appliance” here refers to achieving database and abnormal communication protection (Internet security) functions.

This anomaly prevention (or Internet security) is the detection and elimination of anomalous packets sent from external attackers.

The database performs SQL analysis of packets coming in mass quantities from the numerous dispersed RFID/installed sensors/video sensors, data aggregating and updating for the cache, and the automatic cache data uploading for servers. The database also carries out SQL analysis of data request packets such as from client cellular phone terminals, runs XML translations and data downloads from the cache, and automatically downloads the server data to the cache.

Situations in utilizing the sensors and RFID differ with each user. The contents of the communication packet also differ according to type of sensor/RFID, the application, the installation location, and the time such as day or night. Moreover, the communication state between each terminal sending and receiving packets, differs according to the TCP congestion/transition state, the L (layer) 7 protocol in use, commands in progress, and the progress state of the command in progress.

The functions required for this appliance therefore differ according to the user/application/location/time and each execution state. The appliances containing these functions must also be dispersed on the edge network to make the processing on small servers or internal boards in communication apparatus efficient. Therefore, besides efficiently processing packets by being compact and energy efficient, the processors for these appliances must also be flexible in handling various processing tasks for individual packets based on the communication state between terminals.

However, though both flexibility and high-speed processing with a small size and low power consumption are needed, the general-purpose processors and Application Specific Integrated Circuits (ASIC) of the related art have the problem that they lack either flexibility or high-speed processing capability with a compact size and low power consumption.

The dynamic reconfigurable processor (DRP) on the other hand, contains a processing matrix where numerous processing elements (PE) are connected by a selector. Even at low frequencies the DRP delivers high processing performance at low power consumption by parallel processing. Moreover, the PE connections and processing functions are changed at a minimum of one clock, giving high flexibility by changing the loaded functions within a short time. Multiple processors can therefore execute simple commands in one batch, and combinations of multiple processors can execute complex commands even without raising the operating frequency, so that the parallel processing capability of processing matrix core is enhanced and high processing performance obtained at low power consumption. This DRP can therefore simultaneously process packets at high speed with a compact size and low power consumption, and is also ideal for appliances that must flexibly rewrite algorithms.

When this DRP is used in equipment offering services for application layers such as databases, the logic loaded in the circuit (generally referred to as “configuration”) must be changed according to the communication state between each host sending and receiving packets (transport layer protocol transition/congestion state, type of application layer protocol, type of command in progress, progress state of command in progress (what extent the file has been sent/received)) and different processing must be executed for each packet. The reconfiguring trigger generated by the processor group within the processing matrix starts changing the configuration. The configuration can therefore be swiftly changed by generating information (communication state of each host sending and receiving the received packet) needed for generating the reconfiguring trigger ahead of time outside the matrix, and by directly inputting it into the processing matrix.

The present inventors thereupon propose an apparatus with a dynamic reconfigurable processor (DRP) able to reconfigure each packet based on the communication state between the terminal and host (hereafter, generally referred to as “terminal”) (“Query-Transaction Acceleration Appliance with a DRP using Stateful Packet-by-Packet Self-Reconfiguration” IEICE, vol. 107, No. 41, RECONF207-1, PP. 1-6, May 2007). The present invention utilizes direct input/output of communication data that bypasses the memory. Moreover, the present invention achieves high-speed reconfigurations, by changing the configuration that was loaded in the dynamic reconfigurable processor, based on the communication state between terminals generated beforehand outside the processing matrix; and achieves high performance server services of application layers such as databases in a compact and low-power consumption apparatus.

### SUMMARY OF THE INVENTION

Problems with an apparatus containing the above dynamic reconfigurable processor (DRP) of the related art with packet reconfiguring capability based on the communication state between terminals are described next while referring to FIG. 19.

This apparatus includes a switch 1901 for switching the packets, a dynamic reconfigurable processor (DRP) 1902 serving as a dynamic reconfiguring unit to execute each arithmetic operation, a packet I/O 1900 for controlling the packet input and output between the switch 1901 and the DRP 1902, and an external memory 1903 for accumulating all data types.

The packet I/O 1900 includes a sorter 1904 for sorting the packets received from the switch 1901, the buffers 1905, 1913 for temporarily accumulating the sorted packets, a packet read unit 1906 for reading the packet from the buffer 1905, a communication state table 1910 for accumulating the communication state, a communication state read unit 1907 for reading the communication state, a communication state update unit 1908 for updating the communication state, a communication state write unit 1909 for writing the communication state, a buffer 1911 for temporarily accumulating the updated communication state, a buffer 1912 for temporarily accumulating the loaded packets, and a cluster unit 1914 for gathering the packets.

The sorter 1904 sorts the packets 1915 loaded from the switch 1901, into the packets 1917 requiring processing and, packets 1918 not requiring processing. The packets 1917 requiring processing are accumulated in the buffer 1905.

When the processing starts, the packet read unit 1906 reads the packets 1919 accumulated in the buffer 1905, and transfers them to the communication state read unit 1907, and communication state update unit 1908, and the buffer 1912.

The communication state read unit 1907 reads the corresponding communication state 1922 from the communication state table 1910 based on the transmit source and destination information recorded in the packet 1920, and transfers it to the communication state update unit 1908.

The communication state update unit 1908 updates the communication state 1948 based on the communication status 1948 received from communication status read unit 1907 and packet 1920 received from the packet read unit 1906. The updated communication state 1921 and 1949 are transferred to the communication state write unit 1909 and the buffer 1911.

The communication state write unit 1909 writes the updated communication state 1921 received from the communication state update unit 1908 as the new communication state 1923, into the communication state table 1910.

The DRP1902 includes a PE matrix 1927 containing multiple internal processors and, a general-purpose processor 1928, and configuration data cache 1930, and an SDRAM I/F1931 serving as the interface to the external memory, and a bus switch 1929 joining these components.

The PE matrix 1927 includes a program reconfigurable interrupt generator PE group 1934 for implementing program reconfiguration, an autonomous reconfigurable interrupt generator PE group 1935 for implementing autonomous reconfiguration, a PE group 1936 for implementing L (Layer) 2-7 (mathematical) functions for achieving various functions, and a PE group 1937 for sending TCP-IP checksum calculated packets, and notifying the processing is complete.

The general-purpose processor 1928 executes the OS 1932 and the reconfiguring function 1933 for performing the processing for reconfiguring.

After receiving the updated communication state 1949, from the communication state 1908, the autonomous reconfigurable interrupt generator PE group 1935 generates an autonomous reconfiguring interrupt 1941, based on the communication state that was received.

The configuration data cache (accumulator buffer) 1930 transfers the internally accumulated configuration data to the PE matrix 1927, based on the autonomous reconfiguring interrupt 1941 that was generated.

The PE matrix 1927 then reconfigures the wiring and functions of the internal processor units based on the configuration data 1942 from the configuration data cache 1930.

After receiving the updated communication state 1949 from the communication state update unit 1908, the program reconfigurable interrupt generator PE group 1934 generates a program reconfiguring interrupt 1944 for the general-purpose processor 1928 based on the communication state that was received. Moreover, the based on the received communication state 1949, the configuration data pointer 1938 within the external memory 1903 is rewritten to the address value 1943 where the required configuration data is accumulated.

When the program reconfiguring interrupt 1944 is received from the program reconfigurable interrupt generator PE group 1934, the OS 1932 executes the reconfiguring function 1933.

The reconfiguring function 1933 loads from the configuration data pointer 1938, the address values 1946 where the configuration data to be used next is accumulated, and based on these loaded address values 1946, loads the configuration data 1945 from the configuration data area 1939. Further, based on this loaded configuration data 1945, the reconfiguring function 1933 rewrites the configuration data cache to the new configuration data 1947. Moreover, the reconfiguring function 1933 transfers the rewritten configuration data 1942 to the PE matrix.

The PE matrix 1927 reconfigures the wiring and function of the internal processor units based on the configuration data 1942 from the configuration data cache 1930.

When the configuring of the PE matrix 1927 is completed, the communication state 1924 accumulated in the buffer 1911, and the packets 1925 accumulated in the buffer 1912 are loaded, and transferred to the PE group 1936 executing the L2-7 function.

The PE group 1936 executing the L2-7 function executes each type of processing by utilizing the communication state 1924, the packet 1925, and the data from the OS/application data area 1940 within the external memory 1903. The PE group 1936 sends the changed communication state 1926 to the communication state write unit 1909, and updates the communication state table 1910.

After the PE group 1936 executing the L2-7 function has finished the processing, the PE group 1937 calculates the TCP/IP checksum for the newly generated packets, and sends the calculated packets 1951 one after another to the cluster unit 1914. After all packets are sent, the processing end notification 1950 is sent to the packet read unit 1906.

The cluster unit 1914 gathers the packet 1951 from the PE matrix 1927, and the packets from the buffer 1913, and outputs them to the switch 1901.

After receiving the processing end notification 1950, the packet read unit 1906 reads (or loads) a new packet from the buffer 1905.

The above method achieves a dynamic reconfigurable processor apparatus that reconfigures each packet based on the communication state between terminals. This apparatus utilizes direct input and output of communication data that bypasses the memory. Further, by changing the configuration in the processing matrix within the dynamic reconfigurable processor based on the communication status between hosts generated beforehand outside the processing matrix, the DRP apparatus can change the logic at high speed, and high-performance server services for application layers such as databases achieved in a compact and low-power consumption device.

However, this dynamic reconfigurable processor apparatus handles the processing in the order that the packets arrive. The configuration data being used is therefore different between prior and latter packets, and if the configuration data for implementing the processing is not accumulated within the configuration data cache 1930, then a cache miss occurs, creating a time for loading the configuration data from the external memory 1903 into the configuration data cache 1930. This time causes the problem that a drop in the processing performance occurs.

Moreover in the above dynamic reconfigurable processor apparatus for reconfiguring each packet based on the communication state between terminals, only describes the case where the DRP 1902 contains one PE matrix 1927. There is no description of a method for scheduling the allotment of packets to the PE matrix that is required when the DRP 1902 contains multiple PE matrices 1927.

The present invention has the object of providing an information processing apparatus and information processing system possessing enhanced processing efficiency, and capable of resolving the above problems in the dynamic reconfigurable processor apparatus for reconfiguring each packet based on the communication state between terminals.

In order to achieve the above objects, the present invention includes multiple (PE) matrices in the dynamic reconfigurable processor unit, and by utilizing a scheduling unit to allot packets as needed to these processing matrices can suppress cache misses and reduce the time needed to load the configuration data. Moreover, the loading time required for configuration data due to cache misses can be shortened by pre-reading and transferring the configuration data required for processing the second packet in advance, during the processing of the first packet.

The information processing apparatus of this invention for processing packets sent and received between terminals includes multiple processing matrices in the dynamic reconfigurable processor unit, and a scheduling unit for deciding whether to process the subsequent second and third packets with either the first or the second processing matrix when the first processing matrix is processing the first packet; and when the second packet requires processing based on the same configuration as the first packet and, the third packet requires processing based on configuration information different from the first packet, then the scheduling unit makes the second packet wait until processing of the first packet by the first processing matrix has been completed, and gives the third packet usage priority by the second processing matrix.

The information processing apparatus of this invention includes a communication state table for storing the communication state between terminals sending and receiving packets, and a packet input/output unit containing a communication state update unit for changing the communication state according to the combinations of internal information for the received packet and the communication state loaded from the communication state table based on the internal information in the packet and, a configuration information accumulator buffer for storing multiple configuration information, and a processor unit group where the function and wiring can be changed; and a processing matrix unit for receiving the packet and the changed communication state and, acquiring configuration information from the configuration information accumulator buffer based on the changed communication state, and reconfiguring the wiring and the processor unit group based on the acquired configuration information, and a dynamic reconfigurable processor unit including processor units for transferring configuration information to the configuration information accumulator buffer, and processing only according to the changed communication state in the packet, and a storage unit for storing multiple configuration information; and the processing units for this dynamic reconfigurable processor unit are configured to allow transferring configuration information based on the second communication state required for processing the subsequent second packet, from the storage unit to the configuration information accumulator buffer, while the processing matrix unit is processing the first packet after reconfiguring it based on the first communication state.

The information processing system of this invention contains a server, terminals requesting data to the server over a network, and an information processing apparatus for receiving packets transferred between servers and terminals, and executing processing according to the communication state between the terminals and the server sending and receiving packets, and is characterized in that the information processing apparatus includes; a communication state table for storing the communication state between terminals, and a communication state change unit for changing the communication state according to the combinations of internal information for the received packet and the communication state loaded from the communication state table based on the internal information in the packet and, and a first and second processing matrix containing a processing matrix unit group whose wiring and functions can be changed and a configuration information accumulator buffer for storing multiple configuration information for the processing matrix, and further containing a dynamic reconfigurable processor unit for receiving only the packet and changed communication state, and acquiring configuration information from the configuration information accumulator buffer based on the changed communication state and, reconfiguring the wiring and the functions of the processing unit group of the processing matrix based on the acquired configuration information, and a scheduling unit for deciding whether to process packets subsequent to the first packet, with either the first or the second processing matrix, when the first processing matrix is processing the first packet; in an information processing system that executes processing on a dynamic reconfigurable processor unit according to the changed communication state in a packet, and sends those processing results over a network to a server or a terminal.

The present invention provides an apparatus for improving processing efficiency and achieving high-performance server services for application layers such as databases in a compact, energy-saving and dynamic reconfigurable processing device that reconfigures each packet based on the communication state.

### BRIEF DESCRIPTION OF THE DRAWINGS

FIG. 1 is a block diagram showing the memory and dynamic reconfigurable processor and the packet I/O of the first embodiment;

FIG. 2 is a block diagram showing the information processing apparatus of the first embodiment;

FIG. 3 is a block diagram showing the dynamic reconfigurable processor of the first embodiment;

FIG. 4 is a pictorial diagram showing the operation of the dynamic reconfigurable processor of the first embodiment;

FIG. 5 is a pictorial diagram of the system applied to the first embodiment;

FIG. 6 is a pictorial diagram of the system applied to the first embodiment;

FIG. 7 is a drawing for describing the packet data in the first embodiment;

FIG. 8 is a drawing showing an example of the communication table during processing in the first embodiment;

FIG. 9 is a drawing showing an example of the communication state table in the first embodiment;

FIG. 10 is a drawing showing an example of the communication state table during processing in the first embodiment;

FIG. 11 is a drawing showing an example of a combination of communication states in the first embodiment;

FIG. 12 is a diagram showing an example of communication state transitions in the first embodiment;

FIG. 13 is a diagram showing an example of the reconfiguration cycle for configuration data in the first embodiment;

FIG. 14A is a flow chart during the configuration data pre-reading and loading in the first embodiment;

FIG. 14B is a flow chart showing the transfer of the packet and the changed communication state in the buffer in the first embodiment;

FIG. 15 is a sequence diagram showing TCP communication control in the first embodiment;

FIG. 16 is a sequence diagram showing the download to the front end terminal and the device for the server file in the first embodiment;

FIG. 17 is a sequence diagram showing the registration-updating-selection-deletion of item data of the first embodiment;

FIG. 18 is a sequence drawing showing the upload to the server for item data of the first embodiment; and

FIG. 19 is a block diagram of the dynamic reconfigurable processor apparatus utilizing autonomous-reconfiguring of each packet based on the communication state, as a precondition for this invention.

### DETAILED DESCRIPTION OF THE PREFERRED EMBODIMENTS

The preferred embodiments of the present invention are described next while referring to the drawings.

### First Embodiment

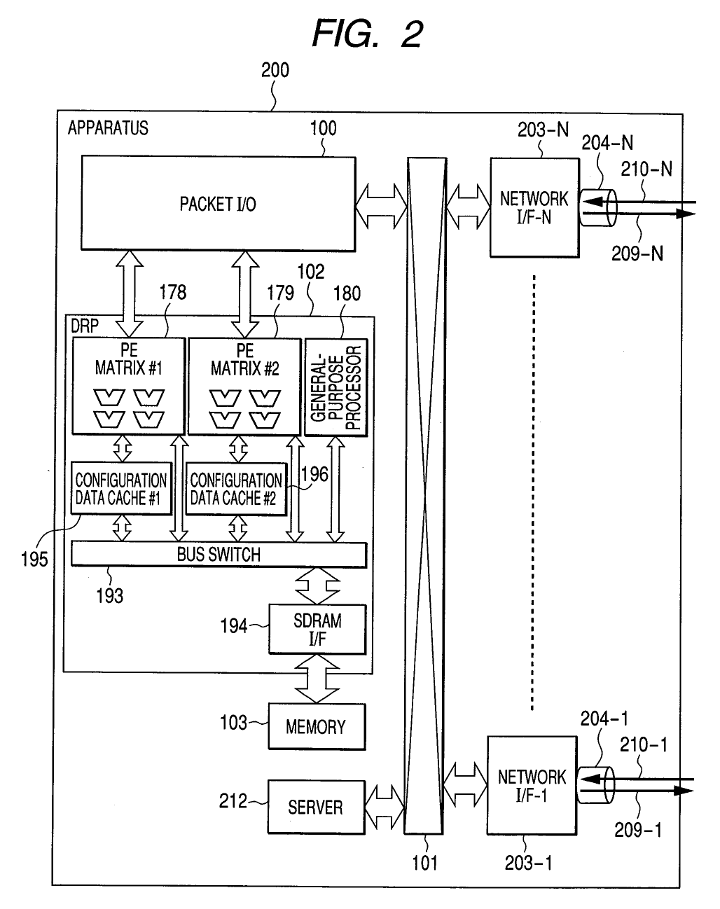

The first embodiment of the information processing apparatus is described next. FIG. 2 is a block diagram showing the structure of the information processing apparatus of the first embodiment.

An information processing apparatus 200 includes a dynamic reconfigurable processor (DRP) 102 as the dynamic reconfigurable processing unit and, a packet input/output unit (packet I/O) 100, and a memory 103 as a storage unit, and a network I/F-i (i=1 through N) 203 (203-1 through 203-N) and, a communication line connector unit 204 (204-1 through 204-N), and a switch 101.

This apparatus 200 connects to the network and transfers the (210-1 through 210-N) packets received over the network via the network I/F 203, to the packet I/O 100 or another network I/F 203. Further, this apparatus 200 sends (209-1 through 209-N) the packets from the packet I/O 100 or another network I/F 203 to the network via the network I/F 203.

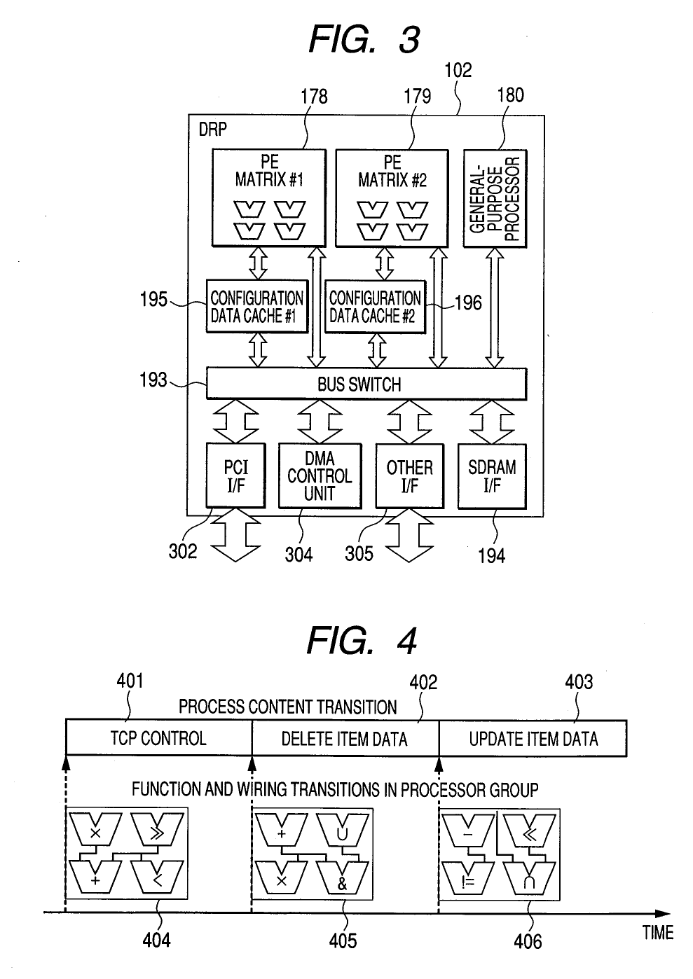

FIG. 3 is a block diagram showing in detail the structure of the dynamic reconfigurable processor (DRP) 102 mounted in the apparatus 200.

The dynamic reconfigurable processor 102 includes: a general-purpose processor unit 180 such as an RISC processor, processing matrices (PE matrix#1, 2) 178, 179 each containing multiple compact processor unit whose mutual functions and wiring are variable, a bus switch 193, configuration data caches (#1, 2) 195, 196 that match the processing matrices 178, 179, a PCI I/F302 for connecting the PCI bus, and an external memory access SDRAM I/F 194, a DMA controller 304 for DMA transfer, and other I/F 305 for connecting with other interfaces. The example in this embodiment describes using two processing matrices (PE matrix#1, 2) and two configuration data caches (#1, 2), however three or more may be used. Note that the processing matrices (PE matrix#1, 2) might sometimes be called processing matrix units.

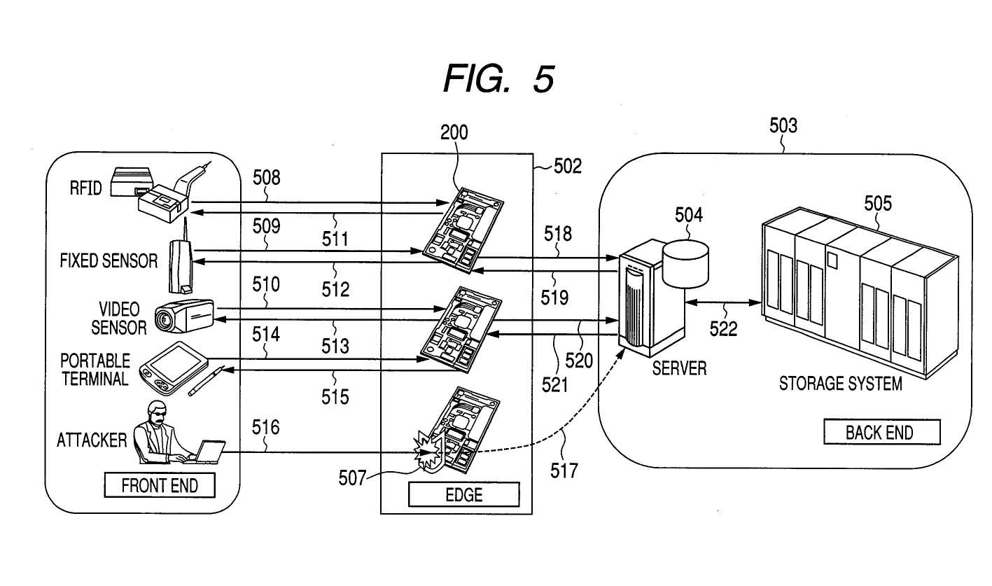

FIG. 4 is a drawing showing an example of the processing matrices 178, 179 in the dynamic reconfigurable processor DRP 102, changing the configuration 404 through 406 for each of the processing contents 401 through 403.

The processing matrices 178, 179 contain numerous compact processor units with variable wiring and functions. The processing matrices 178, 179 change the configuration 404 through 406 by reconfiguring the functions and wiring of each of the compact processor units according to the processing contents 401 through 403. This parallel processing achieves high-speed processing performance as well as high flexibility in changing the configuration within a short time.

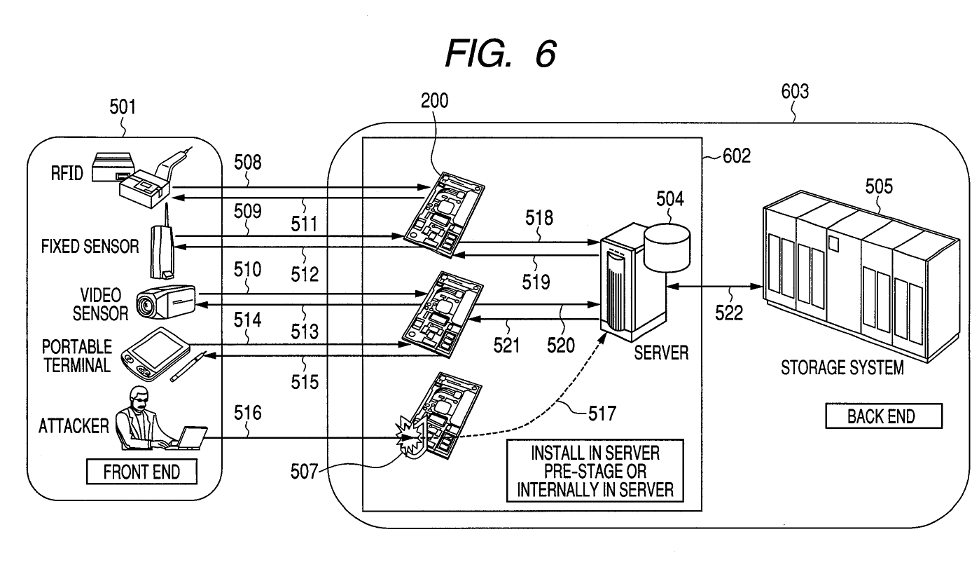

FIG. 5 is a pictorial diagram showing an example of using the apparatus 200 of this embodiment on a network.

An apparatus 200 is installed on an edge network 502 between a back-end system 503 and a front end network 501. A server 504 and a storage system 505 are installed as the back end terminals in the back end system 503. Data for processing from the server 504 is accumulated in the storage system 505 (522).

When the data-updated packets 508, 509, 510 arrive from a front-end terminal such as an RFID/fixed sensor/video sensor, the apparatus 200, changes the data accumulated in the apparatus based on the HTTP/SQL commands recorded in the packet, and returns action instruction packets 511, 512 and an update result notification via a format such as HTML/XML. When the data request packet 514 arrives from the portable terminal, the apparatus searches the data accumulated in the apparatus based on the HTTP/SQL commands recorded in the packet, and sends back a request data return packet 515 via a format such as HTML/XML. Also, when an abnormal packet arrives from an attacker, the apparatus decides this is an abnormal communication and discards it (507) without sending it to the server 504 (517). Further, the apparatus performs the upload 518, 520 to the server, and downloads 519, 521 from the server of data accumulated in the apparatus, and keeps the latest version of the accumulated data.

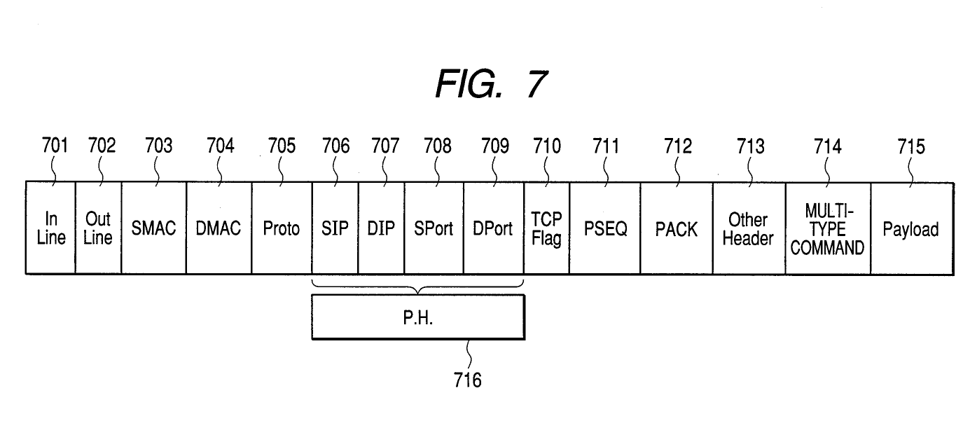

FIG. 6 shows an example of the back end system used by the information processing apparatus 200 of this embodiment.

The apparatus 200 is installed in a pre-stage of the server within the back end system 603 or contains the server internally (602). If the apparatus 200 contains the server, then the switch 101 of the apparatus 200 is connected to the server 212.

The operation of the memory 103 and the packet I/O 100 and the dynamic reconfigurable processor 102 of the information processing apparatus 200 of this embodiment are described next.

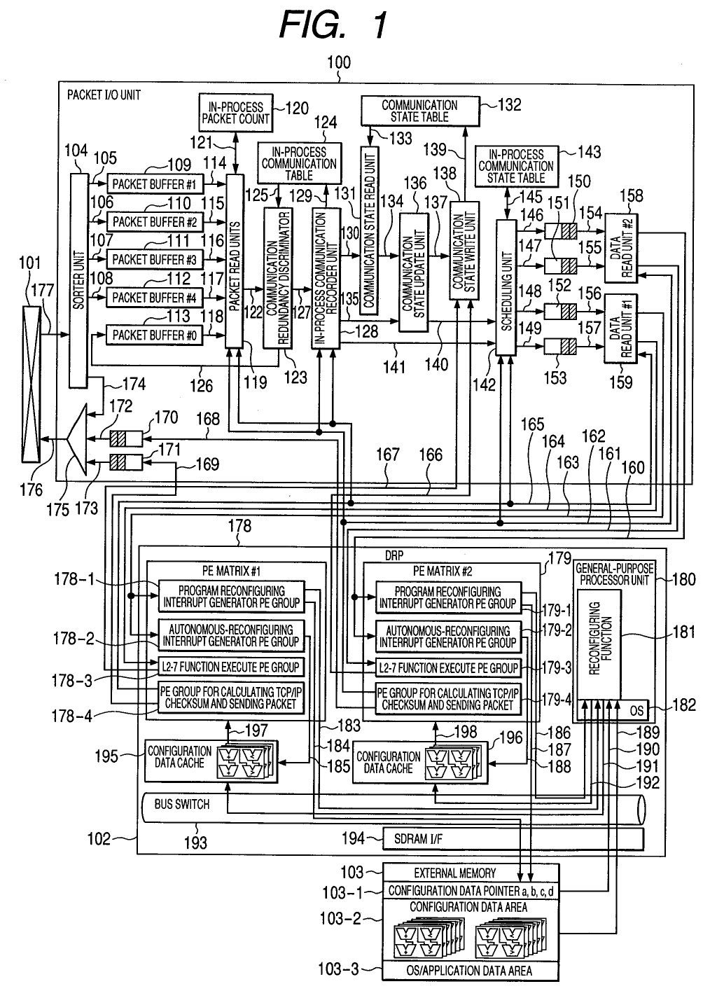

FIG. 1 is a block diagram showing in detail a specific example of the memory 103 and the packet I/O 100 and the dynamic reconfigurable processor 102 of the information processing apparatus 200 of this embodiment.

The packet I/O 100 includes: a sorter unit 104 to decide whether there is a packet for processing or not, and to sort the packet to be processed, and packet buffers #1 through 4 (109, 110, 111, 112) for accumulating the sorted packets, and a packet read unit 119 for reading the packets from the packet buffers #0 through 4, and a in-process packet count 120 for accumulating a count of packets being processed, and a communication redundancy discriminator 123 for deciding whether a communication is being processed or not, and an in-process communication table 124 for accumulating communications being processed, and a packet buffer #0 (113) for re-accumulating the loaded packets when a communication was processed, and an in-process communication recorder unit 128 for recording the in-process communication in the in-process communication table 124, and a communication state table 132 for accumulating the communication state, and a communication state read unit 131, and a communication state update unit 136, and a communication state write unit 138, and an in-process communication state table 143 for accumulating the communication state matching the packet being processed, and a scheduling unit 142 for scheduling a packet based on the communication state matching the packet being processed, and packet buffers 151, 153 for temporarily accumulating the scheduled packet and a communication state matching the packet, and a communication state buffers 150, 152, and data read units (#1, 2) 158, 159 for transferring the communication state and packet at an appropriate timing toward the processing matrices (#1, 2) 178, 179, and the output packet buffers 170, 171 for temporarily accumulating output packets from the PE processing matrices (#1, 2) 178, 179, and a cluster unit 175 for clustering and outputting the packets.

The dynamic reconfigurable processor 102 as explained above, includes: a general-purpose processor unit 180, and processing matrices (PE matrix #1, 2) 178, 179 each containing multiple compact processor unit whose mutual functions and wiring are variable, and configuration data caches (#1, 2) 195, 196, and a bus switch 193, and an external memory access SDRAM I/F 194.

The external memory 103 contains a configuration data area 103-2 for accumulating configuration information that the configuration data caches (#1, 2) 195, 196 cannot hold, and a configuration data pointer a, b, c, d 103-1 containing the address pointer to the configuration data within the configuration data area 103-2, and the OS/application data area 103-3.

The general-purpose processor unit 180 executes the OS 182. The general-purpose processor unit 180 calls up the reconfiguring function 181 after receiving the reconfiguring trigger generated by the processing matrices (#1, 2) 178, 179. The reconfiguring function 181 loaded the configuration data from the configuration data area 103-2, loads it into the configuration data caches (#1, 2) 195, 196, and transfers it to the processing matrix.

The processing matrices (#1, 2) 178, 179 include: autonomous-reconfiguring interrupt generator PE groups 178-2, 179-2 for generating the autonomous-reconfiguring interrupts based on the communication state, and program reconfiguring interrupt generators PE group 178-1, 179-1 for generating program reconfiguring interrupts 183, 186, an L2-7 function execute PE group 178-3, 179-3 formaking external transmissions and generating new packets and changes in the data accumulated in the memory 103 based on the packet and communication state, and PE groups 178-4, 179-4 for calculating the TCP/IP checksum newly generated by the L2-7 function execute PE group 178-3, 179-3 for sending packets.

Each unit of the packet I/O, the reconfigurable processor, and the memory 103 are described in detail next.

When the packets arrive from the switch 101 (177), the sorter 104 for the packet I/O 100 decides if it is packet for processing or not. If the packet does not require processing then it is output to the cluster unit 175 (174). If the packet does require processing then it is output to any one of the packet buffers #1 through 4 (109, 110, 111, 112) according to the contents recorded in the packet header.

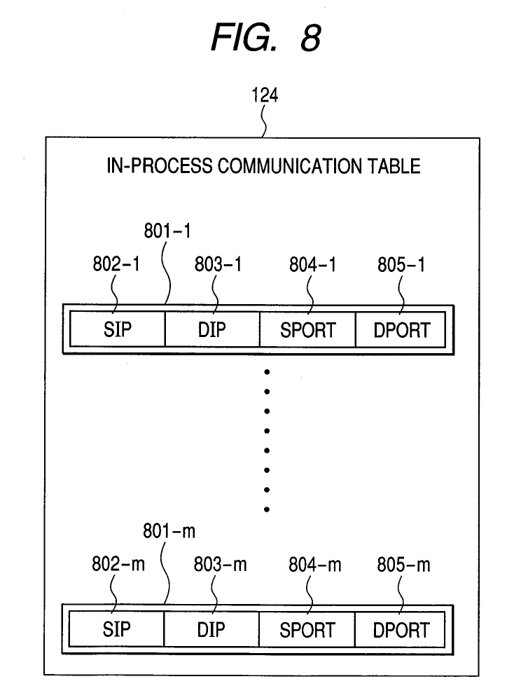

FIG. 7 is a drawing showing a typical format for the packet 177 that the sorter unit 104 received from the switch 101.

The packet 177 contains an InLine 701, an Outline 702, an SMAC703, a DMAC 704, a Proto 705, an SIP 706, a DIP 707, a Sport708, a Dport 709, a TCP Flag710, a PSEQ711, a PACK712, an OtherHeader 713, a (multi-type) command 714, and a Payload 715. Further, in this embodiment, the SIP706, the DIP707, the Sport708, and the Dport 709 are collectively referred to as a P.H. (Packet Header) 716. This P.H. 716 indicates the characteristics of the packet 177.

The InLine 701 stores the input line Nos. serving as identification numbers for the lines where the packet is input. The OutLine 702 stores an output line signal serving as an identification signal for lines to output the packet. The SMAC703 stores the transmit source MAC address serving as the transmit source address for the data link layer. The DMAC704 stores the destination MAC address serving as the destination address. The Proto705 stores the network layer protocol. The SIP 706 stores the transmit source address, or in other words, the transmit source IP address serving as the address for the terminal on the transmit side. The DIP707 stores the destination address, or in other words, the destination IP address serving as the address for the terminal on the receive side. The SPORT708 stores the transmit source port for the TCP. The DPORT709 stores the destination port for the TCP. The TCP Flag710 stores the TCP flag. The PSEQ711 stores the transmit sequence No. (SEQ No.). The PACK 712 stores the receive sequence No. (ACK No.). The OtherHeader 713 stores the other IP/TCP header data. The (multi-type) command 714 stores the application layer (hierarchy) command. The Payload 715 stores the packet header (Packet Header: P.H.) and data other than for each command.

The sorter unit 104 for example, sorts the packets according to the contents of the P.H. (Packet Header) 716 namely the packet characteristics, and outputs any of them to the packet buffers #1 through 4 (109 through 112) according to the sorting results (105 through 108).

The packet read unit 119 reads out (loads) the packet from the packet buffers #0 through 4 (109-113) when the value of the in-process packet count 120 is smaller than a pre-established value. If packets are accumulated in the packet buffer #0 (113), then those packets are given priority in loading (read-out) (118) from the packet buffer #0 (113). If packets are not accumulated in the packet buffer #0 (113), then those packets are loaded (114 through 117) with priority given to packet buffers #1 through 4 (109-112) having the oldest past loading time. Further, the value of the in-process packet count 120 is increased by 1 (121).

When the communication redundancy discriminator 123 receives a packet arrives from the packet read unit 119 (122), it searches (125) the in-process communication table 124 for matching in-process communication information (125) based on the P. H. 176 recorded in the packet.

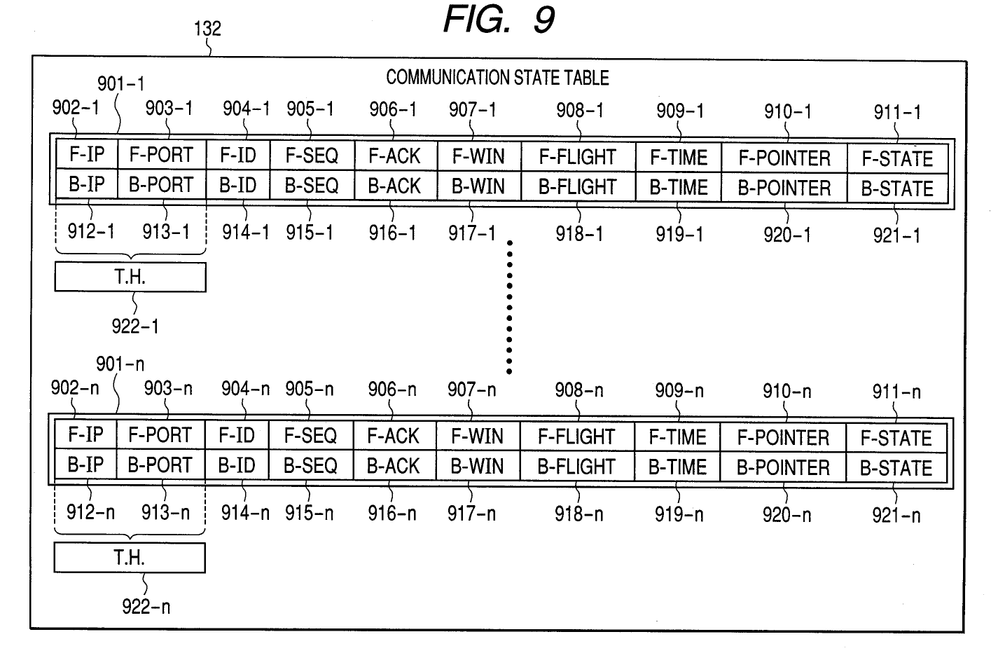

FIG. 8 is a drawing showing an example of the in-process communication table 124.

The in-process communication table 124 contains m number of communication information entries 801 (801-1 through 801-m) equivalent to the number of communications being processed.

The entry 801 contains an SIP802, DIP803, SPORT804, DPORT805, the same as the above described-P.H. (Packet Header).

The SIP802 records the transmit source address for the communication being processed, or in other words the transmit source IP address serving as the address for the host on the transmit side. The DIP 803 records the destination address for the communication being processed, or in other words, the destination IP address serving as the address for the host on the receive side. The SPORT804 records the TCP transmit source port for the communication being processed. The DPORT805 records the TCP destination port for the communication being processed.

The communication redundancy discriminator 123 decides whether or not there is an entry 801 for communication information being processed that matches the P.H. 716 recorded in the packet. If there is a matching entry 801, then the packet 121 that was loaded (or read out) is transferred (126) to the packet buffer #0 (113). If there is not matching entry, then the loaded packet 122 is transferred (127) to the in-process communication recorder unit 128.

The in-process communication recorder unit 128 records the P.H. 716 written in the packet 127 received from the communication redundancy discriminator 123, in the in-process communication table 124 as the communication information being processed (129). The packet 127 received from the communication redundancy discriminator 123 is transferred to the communication state read unit 131, the communication state update unit 136, and the scheduling unit 142 (130, 135, 141).

The communication state read unit 131 loads (or reads out) the communication state matching the P.H. 716 listed in the packet, from the communication state table 132 (133). When there is no communication state in the communication table 132 matching the P.H. 716 listed in the packet, then a new communication state matching the P.H. 716 recorded in the packet is generated.

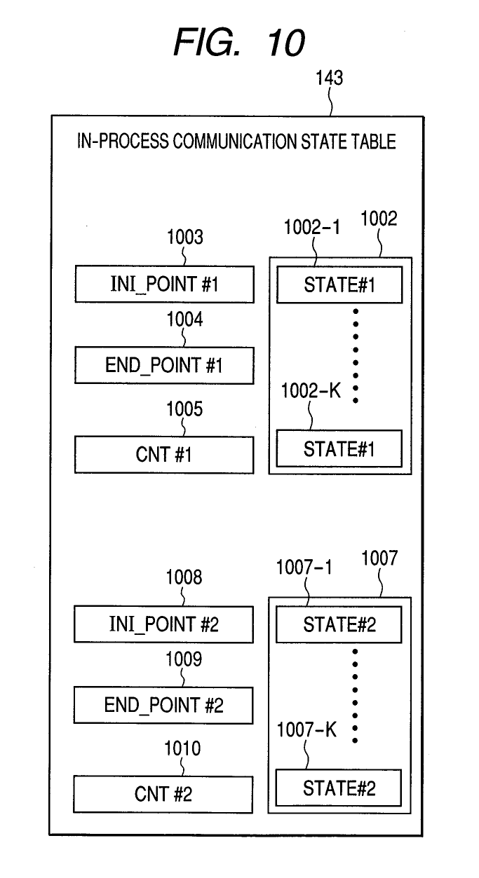

FIG. 9 is a drawing showing an example of the communication state table 132.

The communication state table 132 includes n number of entries 901 (901-1 through 901-n).

The entry 901 contains; the F-IP902, and the F-PORT903, and the F-ID904, and the F-SEQ905, and the F-ACK906, and the F-WIN907, and the F-FLIGHT908, and the F-TIME909, and the F-POINTER910, and the F-STATE911, and the B-IP912, and the B-PORT913, and the B-ID914, and the B-SEQ915, and the B-ACK916, and the B-WIN917, and the B-FLIGHT918, and the B-TIME919, and the B-POINTER920, and the B-STATE921.

The F-IP902 records the IP address on the front end side terminal. The B-IP912 records the IP address on the back end side terminal. The F-PORT903 records the TCP port No. on the front end side terminal. The B-PORT913 records the TCP port No. on the back end side terminal. The F-ID904 records the ID No. for the transmitted packet on the front end side terminal. The B-ID914 records the ID No. for the transmitted packet on the terminal on the back end side terminal. The F-SEQ905 records the transmit source sequence No. on the front end side terminal. The B-SEQ915 records the transmit source sequence No. on the back end side terminal. The F-ACK906 records the destination sequence No. on the front end side terminal. The B-ACK916 records the destination sequence No. on the back end side terminal. The F-WIN907 records the TCP connection congestion control window size of the terminal on the front end side. The B-WIN917 records the TCP connection congestion control window size of the terminal on the back end side. The F-FLIGHT908 records the transmitted window size expressing the transmitted data size already in the terminal on the front end side. The B-FLIGHT918 records the transmitted window size expressing the transmitted data size already in the terminal on the back end side. The F-TIME909 records the most recent time the packet was received from the terminal on the front end side. The B-TIME919 records the most recent time the packet was received from the terminal on the back end side. The F-POINTER910 records the address pointer used by the L2-7 function execute PE group 178-3, 179-3 for executing the different types of processing on the packet received from the terminal on the front end side. The B-POINTER920 records the address pointer used by the L2-7 function execute PE group 178-3, 179-3 for executing the different types of processing on the packet received from the terminal on the back end side. The F-STATE911 records the communication state of communications isolated between the apparatus 200 and the front end terminal. The B-STATE921 records the communication state of communications isolated between the apparatus 200 and the back end terminal. In this embodiment, the F-IP902, the B-IP912, the F-PORT903, and the B-PORT913 are collectively expressed by the T.H. (Table Header) 922.

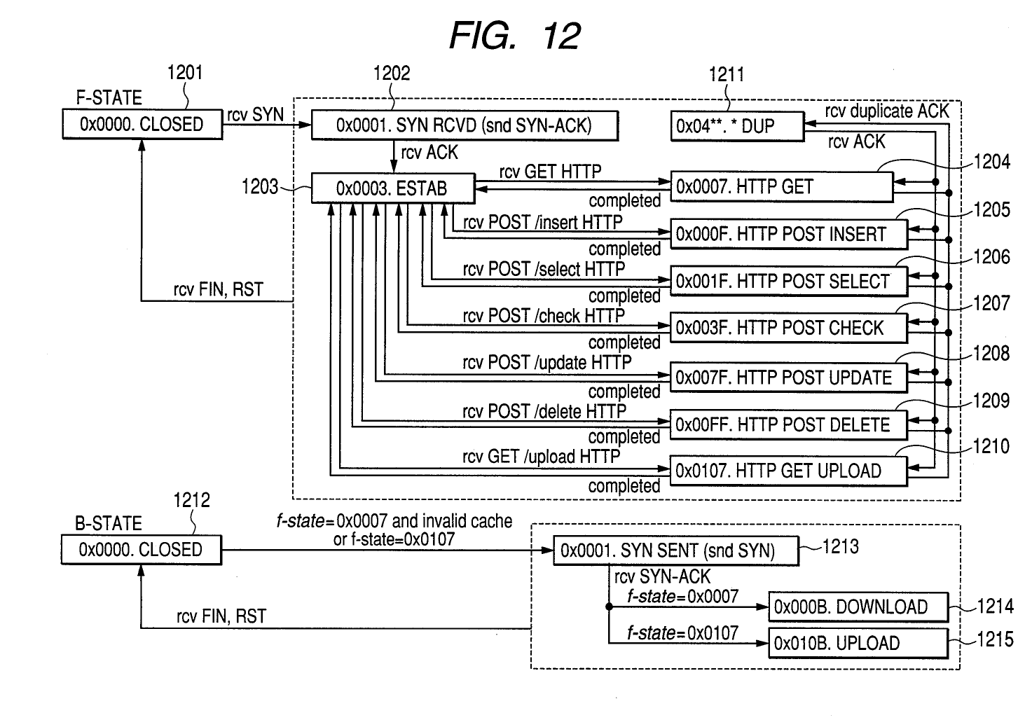

The F-STATE911 and the B-STATE921 for recording the communication states, record values showing any of the combinations shown in FIG. 11. The F-STATE911 and the B-STATE921 record values showing the start or stop (OPEN/CLOSE) 1120 of the TCP connection, and the establishment or fail of the TCP connection (FULL/HALF) 1121, and the TCP connection congestion state (Slow Start/Congestion Avoidance (Cong. Avoid.)/Fast Recovery) 1122, and the presence/absence and type (HTTP/TELNET/FTP) 1123 of application layer protocol 1123, and the presence/absence of command and variables being executed by the application layer protocol and their type (GET/POST, SELECT/INSERT/DELETE) 1124, and the (start) or non-termination (Active) or end (Passive) 1125 of the state of the file sent or received during execution of the command.

The communication state update unit 136 of the packet I/O 100, changes the communication state based on the communication state 134 received from the communication state read unit 131, and the packet 135 received from the in-process communication recorder unit 128. The changed communication state is sent to the communication state write unit 138, and the scheduling unit 140 (137, 140).

The communication state write unit 138 writes the changed communication state 137 received from the communication state update unit 136, into the communication state table 132 (139).

The scheduling unit 142 schedules the packet 141 received from the in-process communication recorder unit 128 by comparing the value in the changed communication state 140 received from communication state update unit 136, with the value recorded in the in-process communication state table 143.

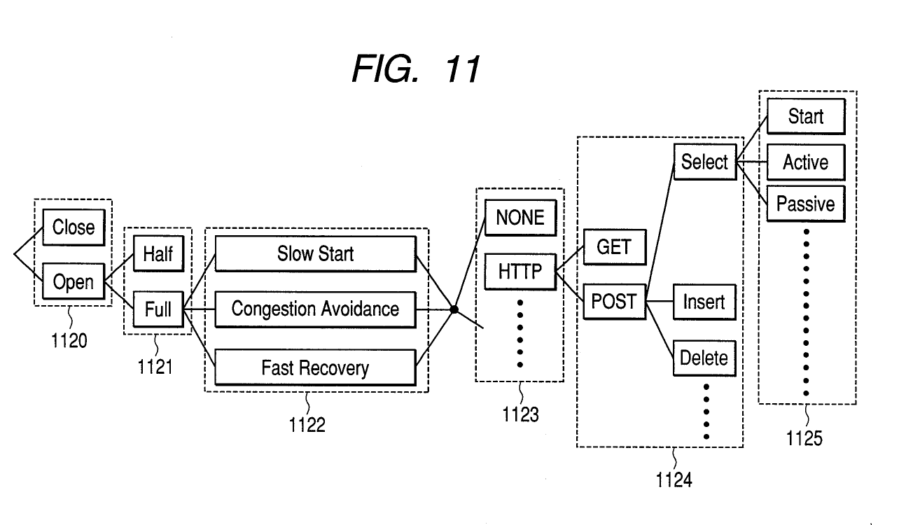

FIG. 10 is a drawing showing a typical in-process communication state table 143.

The in-process communication state table 143 includes an: INI_POINT (#1,2), (1003, 1008), and an END_POINT (#1, 2) (1004, 1009), and a CNT (#1, 2) (1005, 1010), and a STATE#1 (1002) (1002-1 through 1002-k), and a STATE#2 (1007) (1007-1 through 1007-k).

The STATE#L (1002) records the in-progress communication state in the PE matrix #1 (178) and the reconfiguring function 181. The INI_POINT (#1) (1003), records the address pointer for STATE#1 (1002) for recording the communication state that is currently being processed, in PE matrix #1 (178). The END_POINT (#1) (1004) records the address pointer for the STATE #1 (1002) that records the communication state accumulated in the last section of the communication state buffer 152. The CNT (#1) 1005 records the number of communication states currently being processed in the PE matrix #1 (178) and the reconfiguring function 181.

The STATE#2 (1007) records the in-progress communication state in the PE matrix #2 (179) and the reconfiguring function 181. The INI_POINT (#2) (1008) records the address pointer for STATE#2 (1007) for recording the communication state that is currently being processed, in PE matrix #2 (179). The END_POINT (#2) (1009) records the address pointer for the STATE #2 (1007) that records the communication state accumulated in the last section of the communication state buffer 150. The CNT (#2) 1010 records the number of communication states currently being processed in the PE matrix #2 (179) and the reconfiguring function 181.

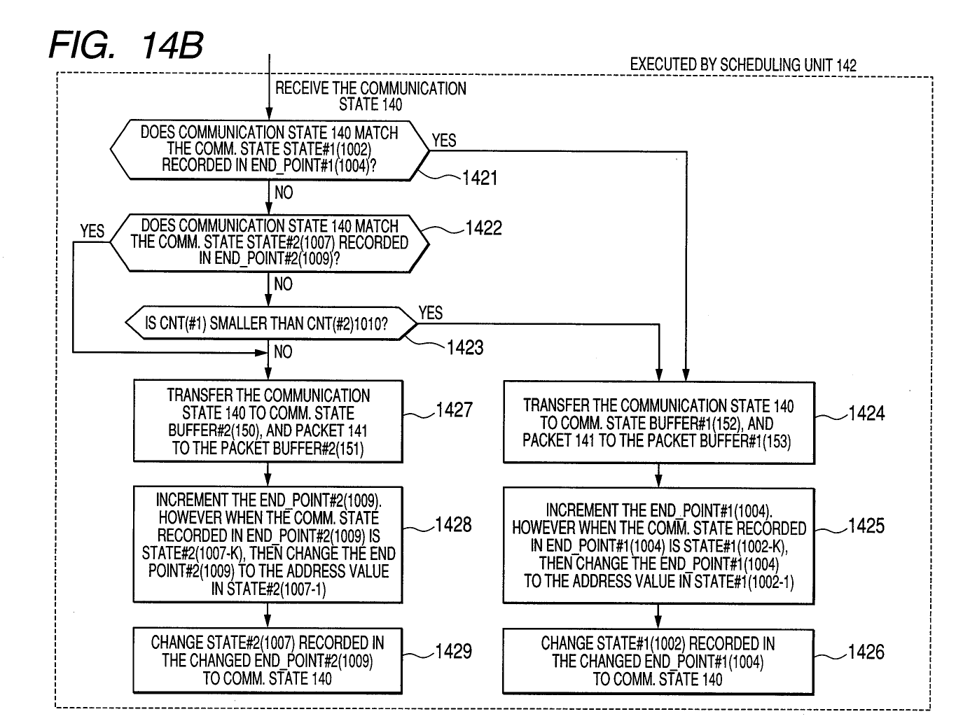

FIG. 14B is a flow chart of the operation when the scheduling unit 142 accepts the packet 141 and the changed communication state 140 from the communication state update unit 136 and the in-process communication recorder unit 128, and transfers them to the buffers 150 through 153 based on the values recorded in the in-process communication state table 143.

The scheduling unit 142 loads (145) the in-process communication state table 143, and compares the value in the changed communication state 140 received from the communication state update unit 136, with the communication state STATE#1 (1002) recorded in the END_POINT#1 (1004) (step 1421); and also compares them with the communication state STATE#2 (1007) recorded in the END_POINT#2 (1009) (step 1422).

If the value in the changed communication state 140 matches the communication state STATE#1 (1002) recorded in the END_POINT#1 (1004) (YES decision in step 1421), then the scheduling unit 142 transfers the changed communication state 140 to the communication state buffer #1(152) (148). The packet 141 received from the in-process communication recorder unit 128 is transferred (149) to the packet buffer #1 (153) (step 1424). Further, the END_POINT#1 (1004) is then incremented. However when the communication state recorded in the END_POINT#1 (1004) prior to incrementing is STATE#1 (1002-k), then the scheduling unit 142 changes the END_POINT#1 (1004) to the address value for STATE#1 (1002) (step 1425). Further, the scheduling unit 142 changes the communication state STATE#1 (1002) listed in the changed END_POINT#1 (1004) to the value in the changed communication state 140 received from the communication state update unit 136 (step 1426).

If the value of the changed communication state 140 matches the communication STATE#2 (1007) recorded in the END_POINT#2 (1009) (YES decision in step 1422), then the scheduling unit 142 transfers that changed communication state 140 (146) to the communication state buffer #2 (150). Further, the packet 141 received from the in-process communication recorder unit 128 is transferred (147) to the packet buffer #2(151) (step 1427). The END_POINT#2 (1009) is incremented. However, when the communication state STATE#2 (1007-k) is recorded in the END_POINT#2 prior to incrementing, then the scheduling unit 142 changes the END_POINT#2 (1009) to the address value of STATE#2 (1007-1) (step 1428). Further, the scheduling unit 142 changes the communication state STATE#2 (1007) recorded in the changed END_POINT#2 (1009) to the value for the changed communication state 140 received from the communication state update unit 136 (step 1429).

When the changed communication state 140 value is different from communication state STATE#1 (1002) shown in END_POINT#1 (1004), as well as the communication state STATE #2 (1007) shown in END_POINT#2 (1009), then the scheduling unit 142 compares the CNT (#1) 1005 value with the CNT (#2) 1010 value (step 1423).

If the CNT (#1) 1005 value is smaller than the CNT (#2) 1010 value (YES decision in step 1423), then the scheduling unit 142 transfers (148) the changed communication state 140 to the communication state buffer #1 (152). The scheduling unit 142 also transfers (149) the packet 141 received from the in-process communication recorder unit 128 to the packet buffer #1 (153) (step 1424). The scheduling unit 142 also increments the END_POINT#1 (1004). However, when the communication state recorded in the END_POINT#1 (1004) before incrementing is STATE#1 (1002-k), then the scheduling unit 142 changes the END_POINT#1 (1004) to the address value of STATE#1 (1002-1) (step 1425). Further, the scheduling unit 142 changes the communication state STATE#1 (1002) recorded in the changed END_POINT#1 (1004), to the changed communication state 140 received from the communication state update unit 136 (step 1426).

When the CNT (#2) 1010 value is smaller than the CNT (#1) 1005 value (NO decision in step 1423), the scheduling unit 142 transfers (146) the changed communication state 140 to the communication state buffer#2 (150). The scheduling unit 142 also transfers (147) the packet 141 received from the in-process communication recorder unit 128, to the packet buffer#2 (151) (step 1427). The scheduling unit 142 also increments END_POINT#2 (1009). However, when the communication state recorded in the END_POINT#2 (1009) before incrementing is STATE#2 (1007-k), then the END_POINT#2 (1009) is changed to the address value of STATE#2 (1007-1) (step 1428). The scheduling unit 142 also changes the communication state STATE#2 (1007) recorded in the changed END_POINT#2 (1009) to the value of the changed communication state 140 received from the communication state update unit 136 (step 1429).

In the above described processing by the scheduling unit 142, when the first processing matrix is processing the first packet, and the second packet requires processing based on the same configuration information as the first packet, and the third packet requires processing based on configuration information different from the first packet, then the second packet is held in standby (made to wait) until the first packet processing in the first processing matrix is completed, and the third packet is given priority for use in the second processing matrix.

When the data read units (#1, 2) 159, 158 receive the processing end notification (165, 162) from the processing matrices (#1, 2) 178, 179, the loading of data starts from the communication state buffers (#1,2) 152, 150 and the packet buffers (#1, 2) 153, 151.

FIG. 14A is a flow chart showing the operation when the data read units (#1, 2) 159, 158 are reading (loading) data from the communication state buffers (#1,2) 152, 150 and the packet buffers (#1, 2) 153, 151.

When the data read units (#1, 2) 159, 158 receive the processing end notification (165, 162), it decides whether the number of packet awaiting processing or whose processing is in progress but not completed, is 1 or not (step 1401).

In step 1401, when the number of packets awaiting processing or whose processing is in progress but not completed, is 1, then the data read units (#1,2) decide whether or not the number of communication states accumulated in the communication state buffers (#1,2) 152, 150 is 2 or more (step 1402).

In step 1402, when the number of communication states accumulated in the communication state buffers (#1,2) 152, 150 is less than 2, then the data read units (#1,2) decide that the number of communication states accumulated in the communication state buffers (#1,2) 152, 150 is 1 or not (step 1403).

In step 1401, when the number of packets awaiting processing or whose processing is in progress but not completed is not 1, then the data read units (#1,2) decide whether the number of communication states accumulated in the communication state buffers (#1,2) 152, 150 is 0 or not (step 1404).

In step 1402, when the number of communication states accumulated in the communication state buffers (#1,2) 152, 150 is two or more, then the data read units (#1,2) load (156, 154) two communication states from the communication state buffers (#1,2) 152, 150, and send (160, 163) to the PE matrices (#1, 2) 178, 179 (step 1406). After loading, the number of communication states in-progress but not completed is changed to 2.

After the data read units (#1,2) 159, 158 complete step 1406, the DRP102 performs step 1410.

In step 1410, the PE groups 178-1, 178-2, 179-1, 179-2 inside the PE matrix (#1, 2) 178, 179 generate the autonomous reconfiguring interrupts 185, 188 or the program reconfiguring interrupts 183, 186 based on the first communication state that was received, and rewrite the address pointer a,c103-1 for the configuration data determined according to the first communication state (184, 187). Further, the program reconfiguring interrupts 183, 186 are generated based on the second communication state that was received, and rewrites the address pointers b, d 103-1 for the configuration data according to the second communication state (184, 187).

If the autonomous reconfiguring interrupts 185, 188 were generated then the DRP102 loads (197, 198) the pre-specified configuration data from the configuration data cache 195, 196 to the PE matrix (#1,2) 178, 179 and reconfigures it. After reconfiguring, the DRP102 loads (157, 155) the first packet matching the first communication state, from the packet buffer (#1,2) 153, 151, transfers it to the PE group 178-3, 179-3 within the PE matrix (#1, 2) 178, 179 and performs the processing.

If the program reconfiguring interrupts 183, 186 were generated, then the OS182 accepts the interrupts 183, 186, and calls up the reconfiguring function 181.

The reconfiguring function 181 reads the configuration data pointer a through d 103-1 (190), and retrieves the configuration data determined by the configuration data pointer a,c 103-1 (specified by first communication state) from the configuration data area 103-2 (189), and loads them into the configuration data cache 195, 196 (191, 192). Further, the DRP102 loads the configuration data loaded from the configuration data caches 195, 196, into the PE matrix (#1,2) 178, 179 (197., 198), and reconfigures them. After reconfiguring, the DRP102 loads (157, 155) the first packet matching the first communication state from the packet buffer (#1,2) 153, 151, and transfers (161, 164) it to the PE group 178-3, 179-3 within the PE matrix (#1, 2) 178, 179, where the processing is performed.

Also, while the PE group 178-3, 179-3 are processing the first packet, the reconfiguring function 181 pre-reads the configuration data determined by the configuration data pointer b,d103-1 (specified by the second communication state) from the configuration data area 103-2 (189), and loads it into the configuration data caches 195, 196 (191, 192).

The above operation concludes the processing in step 1410.

In step 1403, when the number of communication states accumulated in the communication state buffer (#1, 2) 152, 150 is 1, then one communication state (or state) is loaded (156, 154) from the communication state buffer (#1, 2) 152, 150 and sent (160, 163) to the PE matrix (#1,2) 178, 179 (step 1407). After data loading, the data read unit (#12) 159, 158 changes the number of communication states whose current processing is not completed, to 1.

In step 1403, when the number of communication states accumulated in the communication state buffer (#1, 2) 152, 150 is not 1 but is 0; or in step 1404, when the number of communication states accumulated in the communication state buffer (#1, 2) 152, 150 is 0, then the data read unit (#12) 159, 158 reads (156, 154) the communication states after accumulating them in the communication state buffer (#1, 2) 152, 150 and sends them (160, 163) to the PE matrix (#1,2) 178, 179 (step 1409). After data loading, the data read unit (#12) 159, 158 changes the number of communication states whose current processing is not completed, to 1.

After the data loading, the data read unit (#12) 159, 158 completes the step 1407 or the step 1409, the DRP102 performs step 1411.

In step 1411, the PE group 178-1, 178-2, 179-1, 179-2 within the PE matrix (#1, 2) 178, 179 generates the autonomous reconfiguring interrupts 185, 188 or the program reconfiguring interrupts 183, 186 based on the communication states that were received and, rewrites (184, 187) the address pointers a,c 103-1 for the configuration data determined according to the communication state.

If the autonomous reconfiguring interrupts 185, 188 were generated, then the data read unit (#12) reads (197, 198) the pre-specified configuration data from the configuration data caches 195, 196 to the PE matrix (#1, 2) 178, 179 and that data is reconfigured. After reconfiguring, the packets matching the communication state, are retrieved (157, 155) from the packet buffers (#1,2) 153, 151 and transferred to the PE group 178-3, 179-3 within the PE matrix (#1, 2) 178, 179 (161, 164), and processed.

If program reconfiguring interrupts 183, 186 were generated, then the 0S182 accepts the interrupts 183, 186, and calls up the reconfiguring function 181.

The reconfiguring function 181 reads (190) the configuration data pointer a through d 103-1 and retrieves (189) the configuration data determined by the configuration data pointer a,c 103-1 from the configuration data area 103-2, and loads (191, 192) them into the configuration data caches 195, 196. The configuration data that was loaded into the configuration data caches 195, 196 is further loaded into the PE matrix (#1, 2) 178, 179, from the configuration data caches 195, 196 and reconfiguring performed. After the reconfiguring, the packets matching the communication state are retrieved (157, 155) from the packet buffers (#1,2) 153, 151 and transferred to the PE group 178-3, 179-3 within the PE matrix (#1, 2) 178, 179 (161, 164), and processing performed.

The above described operation in this way completes the processing in step 1411.

In step 1404, when the number of communication states accumulated in the communication state buffers (#1, 2) 152, 150 is not 0 but is 1 or more, then one communication state is read out (156, 154) from the communication state buffers (#1, 2) 152, 150, and sent (160, 163) to the PE matrix (#1, 2) 178, 179 (step 1408). After retrieving it, the number of communication states whose current processing is not completed is changed to 2.

After the data read units (#1,2) 159, 158 complete step 1408, the DRP102 performs step 1412.

In step 1412, the PE group 178-1, 178-2, 179-1, 179-2 within the PE matrix (#1, 2) 178, 179 generates the program reconfiguring interrupts 183, 186 based on the received communication state and, rewrites (184, 187) the address pointers b,d 103-1 for the configuration data determined according to the connection states.

If the program reconfiguring interrupts 183, 186 were generated then the OS182 receives the interrupts 183, 186, and calls up the reconfiguring function 181.

The reconfiguring function 181 loads (197, 198) the configuration data that was pre-read 189 and loaded 191, 192 in step 1410 into the PE matrix (#1, 2) 178, 179, and performs reconfiguring. After the reconfiguring, the packet matching the previous received communication state is read (157, 155) from the packet buffers (#1, 2) 153, 151, transferred to the PE group 178-3, 179-4 within the PE matrix (#1, 2) 178, 179, and processed.

The reconfiguring function 181 pre-reads (189) the configuration data set by the configuration data pointer b,d103-1 (specified by newly received communication state) from the configuration data area 103-2 while the PE group 178-3, 179-3 is processing the packets matching the received communication state, and loads that data into the configuration data cache 195, 196 (191, 192).

The above operation completes the processing in step 1412.

In the processing in steps 1401 through 1412 described above, the processing matrix pre-reads and transfers the configuration information required for processing the second packet from the external memory to the configuration data cached based on the configuration state matching the second packet while the first packet is being processed.

After completing the processing in steps 1401 through 1412, the PE groups 178-3, 178-9 perform processing, and outputs the new communication states 166, 167 to the communication state write unit 138.

The communication state write unit 138 writes (139) the new communication states 166, 167 in the communication state table 132.

When the processing in the PE groups 178-3, 179-3 ends, another PE group 178-4, 179-4 calculates the TCP/IP checksum for the newly generated packets, and sends the calculated packets 168, 169 one after another to the packet buffers 170, 171. After all the packets are sent, the PE group 178-4, 179-4 sends processing end notifications 165, 162 to the data read units (#1, 2) 159, 158, the scheduling unit 142, the in-process communication recorder unit 128, and the packet read unit 119.

When the processing end notifications 165, 162 arrive, the scheduling unit 142 increments the values in INI_POINT (#1,2) 1003, 1008 by 1, after deleting the in-processing communication states STATE (#1, 2) 1002, 1007 as specified by the INI_POINT (#1,2) 1003, 1008. However, when the communication state recorded in INI_POINT (#1, 2) 1003, 1008 before incrementing is STATE (#1, 2) 1002-k, 1007-k, then INI_POINT (#1,2) 1003, 1008 are changed to the address values in STATE(#1,2) 1002-1, 1007-1.

When the processing end notifications 165, 162 arrive, the in-process communication recorder unit 128 deletes the lead (beginning) entry 801-1, and rearranges the remaining entries 801 in order starting from the lead entry 801-1.

When the processing end notifications 165, 162 arrive, the packet read unit 119 decrements the value in the in-process packet count 120 by 1.

Finally, the cluster unit 175 gathers the packets 172, 173 read out from the packet buffers 170, 171, and the packet 174 from the sorter unit 104, and sends them to the switch 101.

If comprising multiple PE matrices, the above described apparatus 200 with dynamic reconfigurable processor for reconfiguring the packet based on the communication state, is capable of suppressing cache misses and reducing the time required for loading the configuration data by utilizing the scheduling unit to assign packets to the PE matrices. Further, this apparatus with dynamic reconfigurable processor is capable of reducing the loading time required due to caches misses, by pre-reading and transferring the configuration data required for processing the second packet during processing of the first packet.

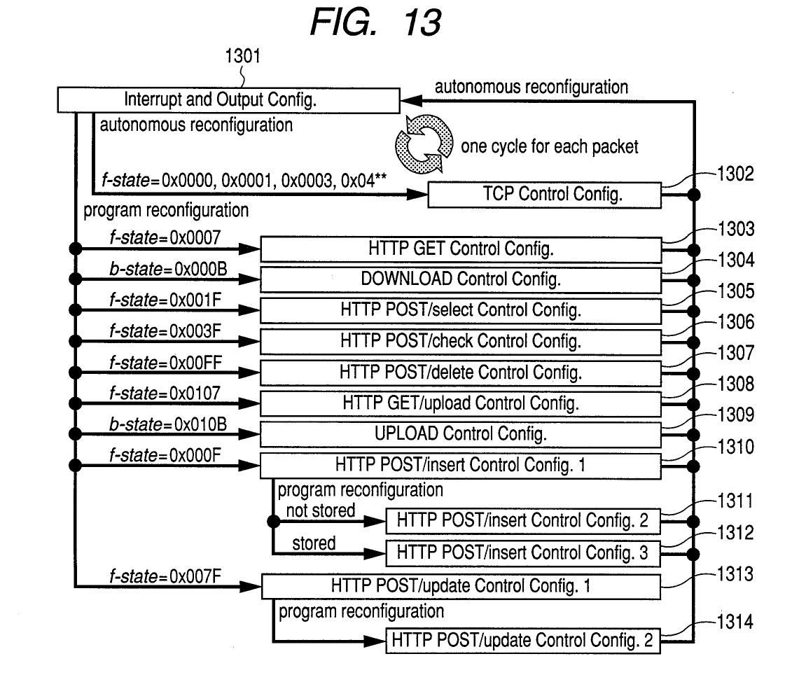

FIG. 12 is a flow chart showing transitions in the communication states (F-STATE911, B-STATE921) accumulated by the communication state table 132.

The F-STATE911 changes according to the packet data, and the F-STATE911 within the communication state table. In the initial (first) stage, the F-STATE911 is ‘0x000’ signifying the TCP connection is “CLOSED” (communication stop) (1201). After receiving the SYN packet (rcv SYN in FIG. 12), the F-STATE911 changes to ‘0x0001’ to signify “SYN RCVD” (start connection) (1202). Further, after receiving the ACK packet, (rcv ACK in FIG. 12), the F-STATE911 changes to ‘0x0003’ to signify “ESTAB” (communication established) (1203).

After the F-STATE911 has changed to ‘0x0003’, it changes according to the arriving packet payload.

When the packet payload contains a GET command within the HTTP protocol, the F-STATE911 changes to ‘0x0007’ to signify “HTTP GET” for requesting the return of the file requested by the client (1204).

When the packet payload contains a POST command including the variable “/insert” within the HTTP protocol, the F-STATE911 changes to ‘0x000F’ to signify “HTTP POST INSERT” for requesting registry into the database for the item data sent by the client (1205).

When the packet payload contains a POST command including the variable “/select” within the HTTP protocol, the F-STATE911 changes to ‘0x0011F’ to signify “HTTP POST SELECT” for requesting selection of item data from the database (1206).

When the packet payload contains a POST command including the variable “/check” within the HTTP protocol, then the F-STATE911 changes to ‘0x003F’ to signify “HTTP POST CHECK” for requesting confirmation of data registry status in the database (1207).

When the packet payload contains a POST command including the variable “/update” within the HTTP protocol, then the F-STATE911 changes to ‘0x007F’ to signify “HTTP POST UPDATE” to request update of items in the database. (1208).

When the packet payload contains a POST command including the variable “/delete” within the HTTP protocol, then the F-STATE911 changes to ‘0x00FF’ to signify “HTTP POST DELETE” to request deleting of item data in the database (1209).

When the packet payload contains a GET command including the variable “/UPLOAD” within the HTTP protocol, then the F-STATE911 changes to ‘0x0107’ to signify “HTTP GET UPLOAD” for requesting upload of data in the item database to the server (1210).

When all processing that was requested by the HTTP protocol commands has ended, after the F-STATE911 changed to ‘0x0007’, 0x000F’, ‘0x001F’, 0x003F’, 0x007F’, ‘0x00FF’, ‘0x0107’, then the F-STATE911 returns to 0x0003’ (1203). Further, when the packet containing a redundant ACK arrives, “0x0400” is added to the F-STATE911, and a “DUP” is attached for requesting fast recovery and fast retransmit by TCP congestion control (1211). When the FIN-ACK/RST-ACK packet arrives, the F-STATE911 automatically returns to ‘0x0000’ regardless of the values in these packets.

The B-STATE921 changes when downloading server data to the cache, or when uploading the database contents accumulated in the cache, to the server.

At the initial state, the B-STATE911 is ‘0x0000’ signifying a “CLOSED” (communication stop) TCP connection state (1212).

When the F-STATE911 is ‘0x0007’, and the file requested by the client has not yet accumulated in the appliance memory, then the B-STATE921 changes to ‘0x0001’ signifying “SYN SENT” (starting connection) (1213). The B-STATE921 also changes to ‘0x001’ signifying “SYN SENT” (starting connection) even when the F-STATE911 is ‘0x0107’ (1213).

Further, when the SYN-ACK packet arrives from the server 504, after the apparatus 200 sent the SYN packet to the back end server 504, and the F-STATE911 is 0x0007, then the B-STATE921 changes to ‘0x000B’ signifying “DOWNLOAD” for requesting download of a file from the server 504 to the apparatus 200 (1214). When the F-STATE911 is ‘0x0107’, then the B-STATE921 changes to ‘0x010B’ signifying “UPLOAD” for requesting upload of the database cached in the memory within the appliance, to the server (1215).

When the FIN-ACK/RST-ACK packet arrives, the B-STATE921 automatically returns to 0 regardless of the values in these packets.

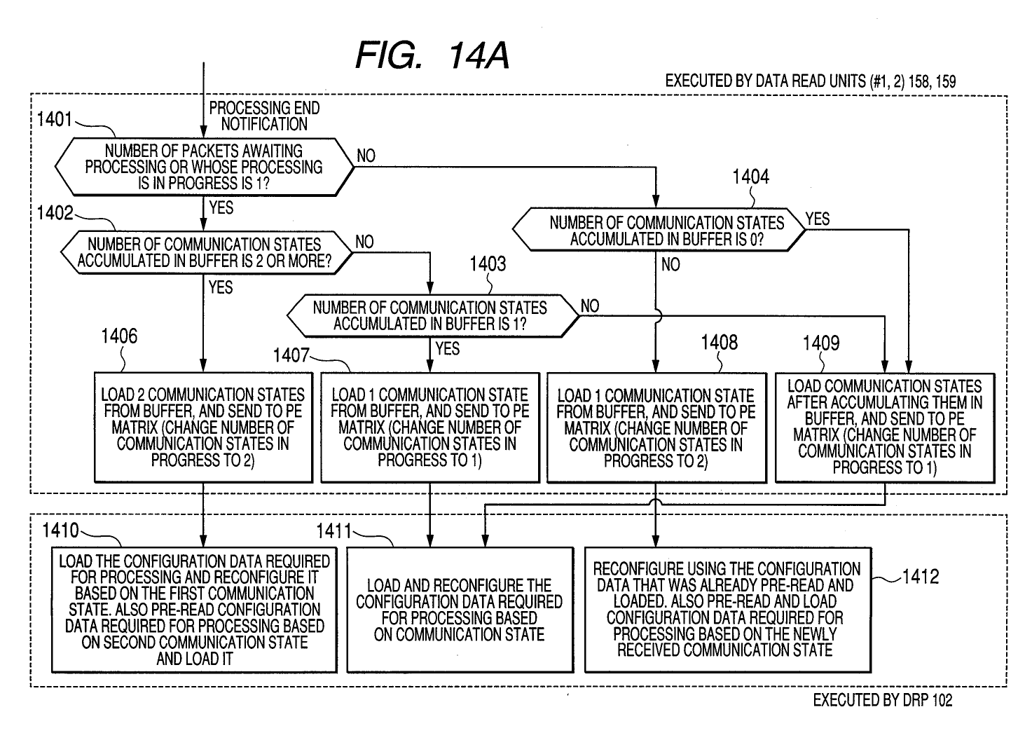

FIG. 13 is a drawing of the configuration data cycle showing the state when the configuration data used according to the communication state, changes in each packet.

The “Interrupt and Output Config.” (1301) is constantly executed during input of communication states from the packet I/O to the DRP. This configuration is executed on all packets, and executes processing to generate interrupts, and processing to calculate TCP/IP checksums and send the packet. This configuration is the most highly utilized and so should preferably be kept cached in the configuration data cache.

The “TCP Control Config.” (1302) is especially for TCP connection control, and is utilized when the communication state for F-STATE911 is ‘0x000’, ‘0x001’, ‘0x0003’, ‘0x04 . . . ’. Besides discarding packets containing abnormal TCP segment sequence/check numbers, this configuration also generates SYN-ACK packets when the communication status is “SYN RCVD”, and generates RST/FIN-ACK and ACK packets when the communication state is “CLOSED”. Further, this configuration is the most highly utilized so should preferably be kept cached in the configuration data cache.

The “HTTP GET Control Config.” (1303) is utilized when the F-STATE911 communication state is ‘0x0007’. First a decision is made whether the file requested by the client is accumulated in the cache. If the requested file is in the cache, then a packet including data for the requested file accumulated in the cache is generated for the client. However if the requested file is not in the cache, then besides generating a SYN packet for making a connection with the back end server, the B-STATE921 is set to ‘0x000B’.

The “DOWNLOAD Control Config.” (1304) is utilized when the F-STATE911 communication state is 0x000B’. This configuration is for downloading a file from the server to the appliance.

The “HTTP POST/select Control Config.” (1305) is utilized when the F-STATE911 communication state is 0x001F’. This configuration selects item data from the DB (database) within the appliance memory according to the contents specified by the packet select command, and generates packets made up of item data translated into HTML/XML text format.

The “HTTP POST/check Control Config.” (1306) is utilized when the F-STATE911 communication state is 0x003F’ This configuration decides whether or not the item data specified by the client is registered in the DB, and generates a packet for notifying the decision results.

The “HTTP POST/delete Control Config.” (1307) is utilized when the F-STATE911 communication state is ‘0x00FF’ This configuration deletes the item data specified by the client from the DB, and generates a packet for notifying the decision results.

The “HTTP GET/UPLOAD Control Config.” (1308) is utilized when the F-STATE911 communication state is ‘0x0107’ This configuration sets the B-STATE921 to ‘0x000B’, and generates an SYN packet for the back end server and, a packet for notifying the client that upload has started.

The “UPLOAD Control Config.” (1309) is utilized when the F-STATE911 communication state is ‘0x010B’. This configuration uploads the contents of the DB accumulated in the appliance memory, to the server.

The “HTTP POST/insert Control Config. 1” (1310) is utilized when the F-STATE911 communication state is ‘0x000F’. This configuration decides whether the data inserted from the client is already registered in the DB or not. If the decision results show that the data inserted by the client is not registered in the DB, the DRP utilizes the “HTTP POST/insert Control Config. 2” (1311). This configuration inserts item data sent from the client into the DB within the appliance memory, and generates a packet informing the client that the data was inserted correctly. However, if the data from the client was registered in the DB, then the DRP utilizes the “HTTP POST/insert Control Config. 3” (1312). This configuration generates a packet for outputting an error message.

The “HTTP POST/update Control Config. 1” (1313) is utilized when the F-STATE911 communication state is ‘0x007F’. This configuration deletes the item data specified by the client as the object for updating, from the DB. The operation then switches to the “HTTP POST/update Control Config. 2” (1314) for reconfiguring. This configuration registers the item data updated by the client, into the DB.

When the different processing for each communication state ends, the PE matrix is reconfigured to the initial configuration “Interrupt and Output Config.” by autonomous reconfiguring.

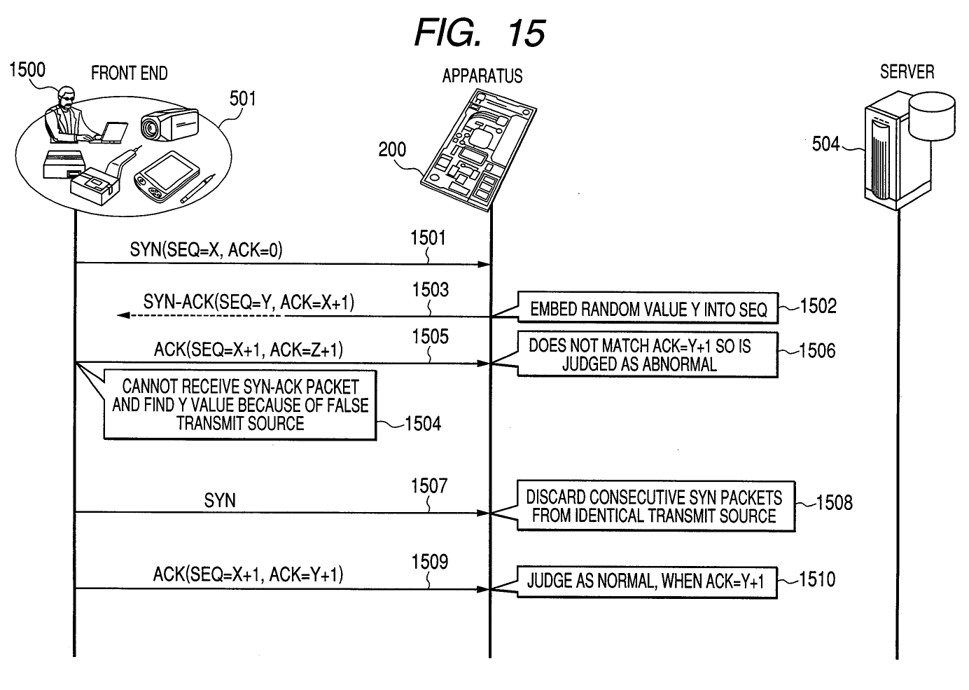

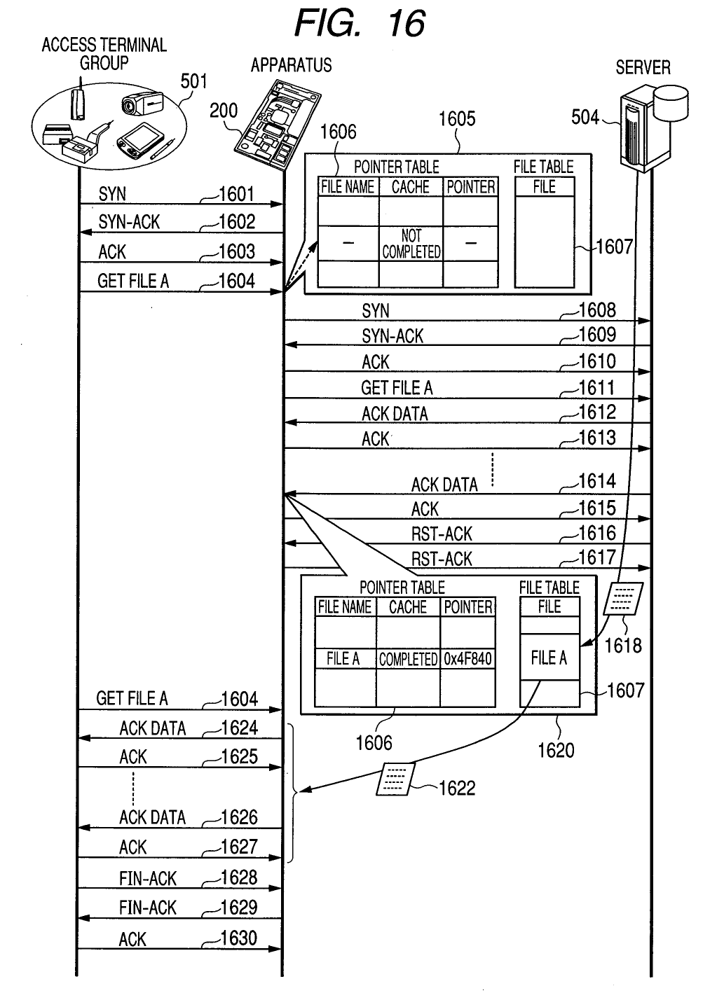

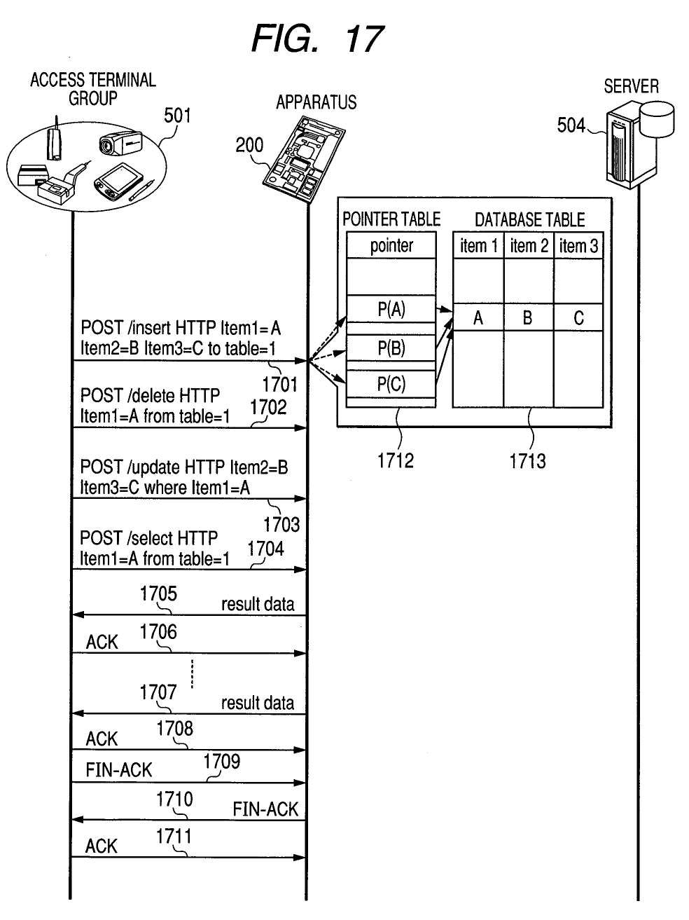

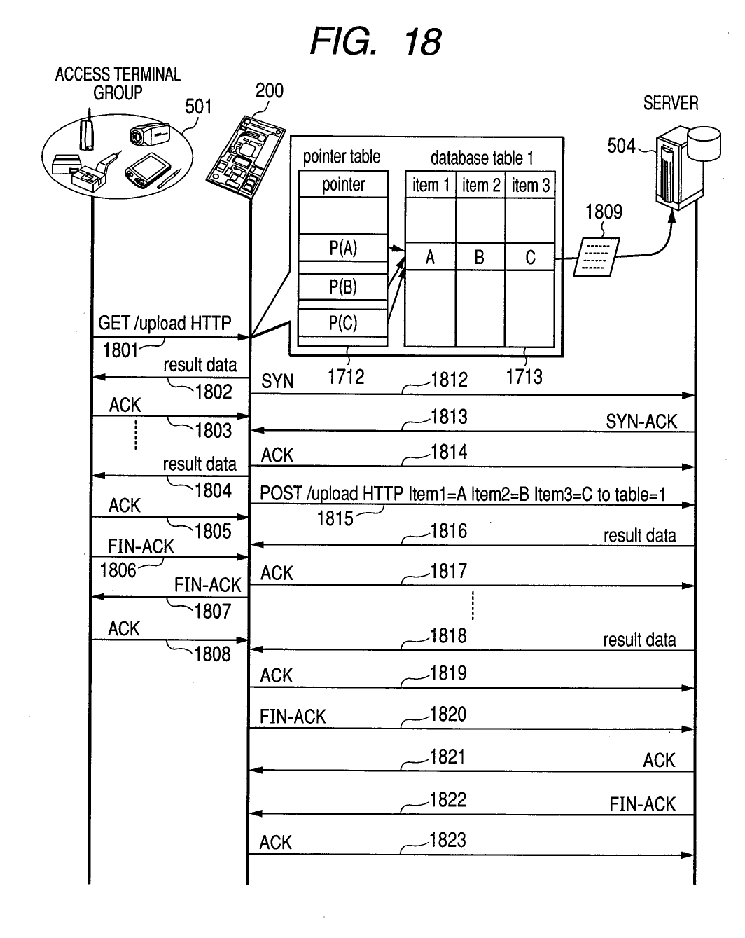

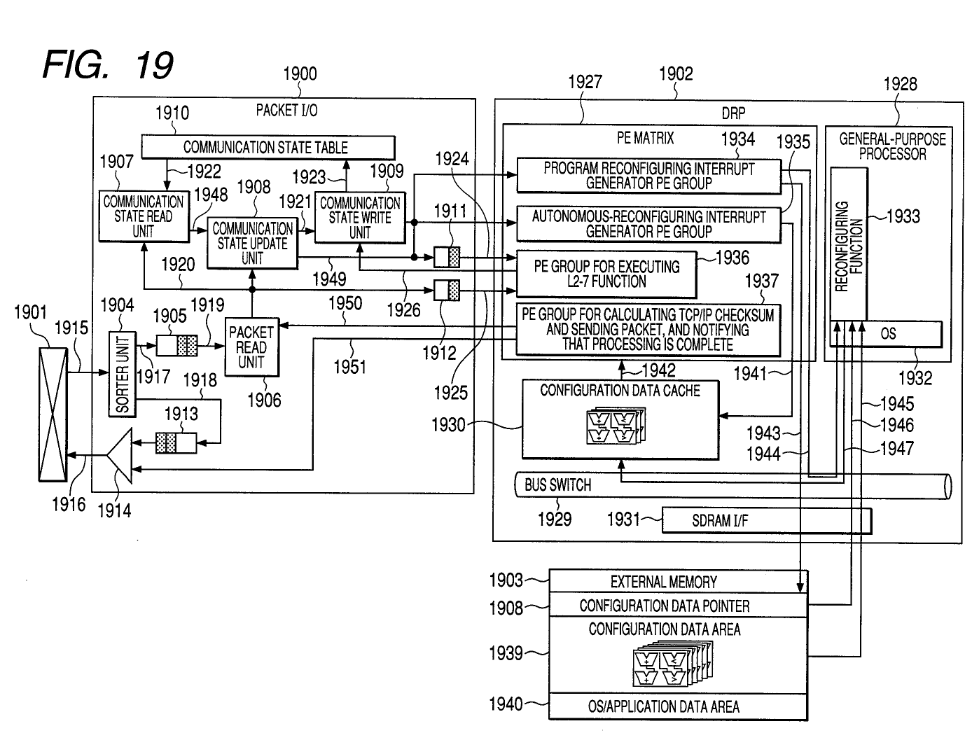

FIG. 15, FIG. 16, FIG. 17 and FIG. 18 are drawings showing the server service sequence achieved by the apparatus 200.

FIG. 15 shows the TCP connection control implemented by “TCP Control Config.” (1302). When a connection request packet arrives (1501) from the front end 501 terminal, for the server 504 serving as the back end terminal, the apparatus 200 attaches a random value y to the SEQ No. (1502), and returns the SYN-ACK packet (1503). If the transmit source for the connection request packet is an attacker 1500 utilizing a transmit source with a false name, then that attacker 1500 cannot receive the SYN-ACK packet and so does not know the Y value (1504). The ACK packet (1505) from the attacker 1500 does not contain the correct value Y+1, and so is judged abnormal and discarded (1506). The continuous transmit SYN packet (1507) from the same transmit source is also discarded (1508). The apparatus 200 judges that communication is normal at the point in time that the ACK number Y+1 serving as the ACK packet (1509) is received, and establishes the TCP communication.

FIG. 16 is a sequence diagram showing the download of a file from the server 504 to the apparatus 200 using the “DOWNLOAD Control Config.” (1304) and, the download of a file from the apparatus 200 to the front end terminal 501 using the “HTTP GET Control Config.” (1303).

First, the access terminal 501 and the apparatus 200 exchange an SYN packet 1601 an SYN-ACK packet 1602, and an ACK packet 1603 by way of a TCP 3-Way-Handshake, and establish TCP communication. The access terminal 501 then utilizes the HTTP GET command to send a packet 1604 requesting the file A.

The apparatus 200 contains a file table 1607 for caching files from the server, and a file pointer table 1606 for recording address pointers in each file.

When the packet 1604 for requesting file A arrives, a search is made of the file pointer table 1606, and a decision is made on whether the file A requested by the GET command is present in the cache or not (1605).

If the file A is not cached in the file table 1607, then a TCP 3-Way-Handshake establishes a connection with the server 504 by utilizing the SYN packet 1608, and the SYN-ACK packet 1609 and the ACK packet 1610. Also, a packet 1611 requesting the file A is sent, and the file A held by the server 504 (1618) is downloaded in accordance with TCP control (1611 through 1617), and recorded in the file table 1607. The name of file A, and the address pointer where the file A is cached are recorded in the file pointer table 1606 and, the file accumulation ends (1620).

When the file A is cached in the file table 1607, this cached file A in the file table (1622) is returned under TCP control to the front end terminal 501 (1624 through 1630).

FIG. 17 shows the registry of item data into the apparatus 200 from the front end terminal 504 by the “HTTP POST/insert Control Config. 1-3” (1310 through 1312; and the selecting of item data within the apparatus 200 by the “HTTP POST/select Control Config.” (1305); and the updating of item data within the apparatus 200 by the “HTTP POST/update Control Config. 1,2” (1313, 1314); and the deletion of item data within the apparatus 200 by the “HTTP POST/deleteControl Config. 1,2” (1307).

The apparatus 200 contains a database table 1713 for caching database entries for the server; and a pointer table 1712 for recording multiple pointers according to items including the entries.

When the packet 1701 with an attached POST command for requesting registry of an entry made up of three item data arrives at the apparatus 200 in HTTP protocol, the apparatus 200 then utilizes the pointer table 1712 to decide whether or not the entry requested for registry, is already registered in the database table. If not registered, then the apparatus 200 generates multiple pointers using the three item data, and registers them in the pointer table 1712. The entry whose registry was requested is also registered in the database table 1713.

When the packet 1702 with an attached POST command for requesting deletion of an entry holding specified item data arrives at the apparatus 200 in HTTP protocol, the apparatus 200 deletes the pointer generated by the entry containing the item data of the entry whose deletion was requested, and the entry holding the item data for deletion from the database table 1713 and the pointer table 1712.

When the packet 1703 with an attached POST command for requesting updating of an entry holding specified item data arrives at apparatus 200 in HTTP protocol, the apparatus 200 deletes the pointer generated by the entry containing the item data of the entry whose updating was requested, and the entry holding the item data for updating, from the pointer table 1712 and the database table 1713. The apparatus 200 further inserts a pointer generated by using three new item data, and an entry made up of three new item data, into the pointer table 1712 and the database table 1713.

When the packet 1704 with an attached POST command for requesting selecting of an entry holding specified item data arrives at the apparatus 200 in HTTP protocol, the apparatus 200 selects the entry holding the item data whose selection was requested from the pointer table 1712 and the database table 1713.

When the processes for registering, updating, selecting and deleting the data are completed, the processing results are returned under TCP control to the front end terminal (1705 through 1711).

FIG. 18 is a diagram showing the upload of item data from the database table 1713 within the apparatus 200 to the server 504 by the “UPLOAD Control Config” (1309).

The apparatus 200 receives a packet 1801 attached with a GET command for requesting the uploading of item data cached into the database table 1713 to the server 504. The apparatus 200 then connects to the server 504 by way of a TCP 3-Way-Handshake utilizing the SYN packet 1812 and the SYN-ACK packet 1813 and the ACK packet 1814. The apparatus 200 then sends a packet 1815 requesting upload of the item data, and uploads the item data under TCP control (1816 through 1823). The server 504 then updates the contents of the database utilizing that uploaded data. Under TCP control, the apparatus 200 also notifies the access terminal 504 of the upload results (1802 through 1808).

By utilizing the dynamic reconfigurable processor apparatus to implement the processing described above using FIG. 12 and FIG. 13, and FIG. 15 through FIG. 18, varied server services can be achieved by reconfiguring each packet based on the communication states among the terminals.

What is claimed is:

1. An information processing apparatus for processing packets sent and received over a network, comprising:
a communication state table for storing the communication state of the packets sent and received between terminals;
a communication state update unit for changing the communication state according to the combination of internal information in the received packet and the communication state read from the communication state table based on the internal information in the packet;
a dynamic reconfigurable processor unit including a first and second processing matrix containing a processor unit group whose functions and wiring are variable, and a configuration information accumulator buffer for storing multiple configuration information for the processing matrix, for receiving the packet and the changed communication state, and acquiring configuration information from the configuration information accumulator buffer based on the changed communication state, and reconfiguring the wiring and the functions of the processor unit group of the processing matrix based on the acquired configuration information; and
a scheduling unit for deciding whether the first or the second processing matrix shall process the subsequent second packet, when the first processing matrix is processing the first packet.

2. An information processing apparatus according to claim 1, wherein
the scheduling unit makes the second packet wait until the processing of the first packet in the first processing matrix has ended, and makes the second processing matrix perform processing giving priority to the third packet,
when the second packet requires processing based on configuration information identical to the first packet, and the subsequent third packet requires processing based on configuration information different from the first packet.

3. An information processing apparatus according to claim 1, further comprising:
an in-process communication table for recording the packet header of the packet being processed;
an in-process communication recorder unit for recording the packet header of the packet whose processing was started in the in-process communication table, and deleting the header of the packet whose processing was completed from the in-process communication table; and
a communication redundancy discriminator for comparing the packet header recorded in the in-process communication table, with the packet header of the packet that was input from the network, and starting the processing of the input packet when these two packet headers are not a match.

4. An information processing apparatus according to claim 1, further comprising:
an in-process communication state table for recording the communication state of the packet awaiting processing or being processed in the processing matrix;
a first and a second communication state buffer for temporarily accumulating the communication state changed by the communication state update unit; and
a first and second packet buffer for temporarily accumulating packets matching the changed communication state,
wherein the scheduling unit decides the first and the second packet buffer as well as the first and the second communication state buffer for accumulating the packets matching the changed communication state, by comparing the changed communication state, with the communication state recorded in the in-process communication state table.

5. An information processing apparatus according to claim 1, further comprising:
a packet buffer for temporarily accumulating the packets;
a communication state buffer for temporarily accumulating the changed communication state; and
a data read unit for reading only the packet and changed communication state from the packet buffer and communication state buffer and transferring them to the processing matrix,
wherein the data read unit decides the number of communication states read from the communication state buffer based on the number of communication states accumulated in the communication state buffer, and the number of packets awaiting processing or being processed in the processing matrix.

6. An information processing apparatus according to claim 1, further comprising:
a storage unit for storing multiple configuration information from the processing matrix, and connected to the dynamic reconfigurable processor unit; and
the dynamic reconfigurable processor unit further contains processor units for transferring configuration information from the storage unit to the configuration information accumulator buffer,
wherein the processor units transfer the configuration information required for processing the second packet, from the storage unit to the configuration accumulator buffer based on the second communication state, while the processing matrix processes the first packet, after the reconfiguring based on the first communication state.

7. An information processing apparatus for processing packets sent and received between the terminals over network, comprising:
a packet input/output unit including a communication state table for storing the communication state between the terminals that send and receive the packet, and a communication update unit for changing the communication state according to the combination of internal information on the packet that was received and the communication state read from the communication state table based on the internal information in the packet;
a dynamic reconfigurable processor unit respectively having a configuration information accumulator buffer for storing multiple configuration information and processor unit group whose functions and wiring are variable, and including a processing matrix unit for receiving the packet and the changed communication state and, acquiring configuration information from the configuration information accumulator buffer based on the changed communication state, and reconfiguring the wiring and functions of the processor unit group based on the acquired configuration information, and a processing unit for transferring the configuration information to the configuration information accumulator buffer, to perform the processing according to the changed communication state to the packet; and
a storage unit for storing multiple configuration information,
wherein the processor unit within the dynamic reconfigurable processor unit transfers the configuration information based on the second communication state required for subsequent processing of the second packet, from the storage unit to the configuration information accumulator buffer, while the processing matrix unit processes the first packet after reconfiguring based on the first communication state.

8. An information processing apparatus according to claim 7,
wherein the processing matrix unit for the dynamic reconfigurable processor unit contains a first and a second processing matrix for reconfiguring the functions and the wiring of the processor unit group based on the configuration information, and
wherein the packet input/output unit further includes a scheduling unit for deciding whether the first processing matrix or the second processing matrix will perform the processing of the second packet, when the first processing matrix is processing the first packet.

9. An information processing apparatus according to claim 7, wherein the packet input/output unit further includes:
a packet buffer for temporarily accumulating packets;
a communication state buffer for temporarily accumulating the changed communication states; and
a data read unit for reading the packet and one or multiple communication states, and transferring them to the processing matrix unit,
wherein the data read unit decides the number of communication states to read from the communication state buffer based on the number of communication states accumulated in the communication state buffer, and the number of packets awaiting processing or being processed in the processing matrix unit.

10. An information processing apparatus according to claim 7, wherein the packet input/output unit further includes:
an in-process communication table for recording the packet header of the packet being processed;
an in-process communication recorder unit for recording the packet header of the packet whose processing was started in the in-process communication table, and deleting the packet header of the packet whose processing was completed, from the in-process communication table; and
a communication redundancy discriminator for comparing the packet header recorded in the in-process communication table, with the packet header of the packet that was input from the network, and starting the processing of the input packet only when these two packet headers are a not a match.

11. An information processing apparatus according to claim 7, wherein the packet input/output unit further includes:
a sorter unit for sorting the packets input from the network;
multiple packet buffers for accumulating the packets sorted by the sorter unit; and
a packet read unit for reading only the sorted packets from the packet buffer.

12. An information processing apparatus according to claim 8, wherein
when the second packet requires processing based on configuration information identical to the first packet, and the subsequent third packet requires processing based on configuration information different from the first packet,
then the scheduling unit makes the second packet wait until the processing of the first packet in the first processing matrix has ended, and makes the second processing matrix give priority to use of the third packet.

13. An information processing apparatus according to claim 8, wherein the packet input/output unit further includes:
an in-process communication state table for recording the communication state of the packet awaiting processing or being processed in the first and the second processing matrix;
a first and a second communication state buffer for temporarily accumulating the communication state changed by the communication state update unit; and
a first and second packet buffer for temporarily accumulating packets matching the changed communication state, wherein the scheduling unit decides the first and the second packet buffer as well as the first and the second communication state buffer for accumulating the packets matching the changed communication state, by comparing the changed communication state, with the communication state recorded in the in-process communication state table.

14. An information processing apparatus according to claim 11, wherein the packet read unit reads the sorted packets, gives priority to packets with the oldest past read-out time in the packet buffer, and starts changing the communication state by using the communication state update unit.

15. An information processing apparatus according to claim 11, wherein the packet input/output unit further includes:
a cluster unit for gathering and outputting packets judged as not requiring processing in the sorter, and packets newly generated by processing in the processing matrix unit.

16. An information processing apparatus according to claim 13, wherein the packet input/output unit further includes:
a first and a second data read unit for reading the packet and the changed communication state from the first and the second communication state buffers and the first and the second packet buffers, and transferring the packet and the changed communication state respectively to the first and the second processing matrix,
wherein the first and the second data read unit decide the number of communication states for reading from the first and second communication state buffer based on the number of communication states accumulated in the first and the second communication state buffers, and the number of packets awaiting processing or currently being processed in the first and the second processing matrices.

17. An information processing system including a server, and terminals for requesting data to a server over a network, and an information processing apparatus for receiving packets transferred between the terminals and the server, and executing processing according to the communication state between the terminals and the server for sending and receiving the packets, the information processing apparatus comprising:
a communication state table for storing the communication state between the server and the terminals;
a communication state update unit for changing the communication state according to the combination of the internal information in the received packet and the communication state read from the communication state table based on the internal information in the packet;
a dynamic reconfigurable processor unit including a first and second processing matrix containing processor unit group whose functions and wiring are variable, and a configuration information accumulator buffer for storing multiple configuration information for the procession matrix, for receiving the packet and the changed communication state, and acquiring configuration information from the configuration information accumulator buffer based on the changed communication state, and reconfiguration the wiring and the functions of the processor unit group of the processing matrix based on the acquired configuration information; and
a scheduling unit for deciding whether the first and second processing matrix shall process the subsequent second packet, when the first processing matrix is processing the first packet,
wherein the dynamic reconfigurable processor unit executes the processing matching the changed communication state in the packet, and sends those processing results to the server or the terminals over the network.

18. An information processing system according to claim 17, wherein the communication state stored by the communication state table includes:
a transport layer protocol transition/congestion state between the terminals and the server and, the application layer protocol types, and types of command variables and commands executed by the application layer protocol, and the progress state of the executed command.

19. An information processing system according to claim 17 wherein the information processing apparatus further includes:
a storage unit for storing multiple configuration information,
wherein the dynamic reconfigurable processor unit further contains a processor unit for transferring the configuration information from the storage unit to the configuration accumulator buffer, and the processor unit transfers configuration information required for processing the second packet from the storage unit to the configuration information accumulator buffer while the processing matrix processes the first packet.

20. An information processing system according to claim 17 wherein the scheduling unit for the information processing apparatus makes the second packet wait until the processing of the first packet in the first processing matrix has ended, and makes the second processing matrix perform processing giving priority to the third packet when the second packet requires processing based on configuration information identical to the first packet, and the subsequent third packet requires processing based on configuration information different from the first packet.
